(19) United States
(12) Patent Application Publication
(10) Pub. No.: US 2010/0097208 A1
(43) Pub. Date: Apr. 22, 2010

(54) Method and System for Tracking Assets

(75) Inventors: Howard S. Rosing, Naples, FL (US); Richard J. Cross, Wilmington, DE (US)

Correspondence Address: PATENT CORRESPONDENCE;ARNALL GOLDEN GREGORY LLP, 171 17TH STREET NW, SUITE 2100, ATLANTA, GA, 30363, US

(73) Assignee: G-Tracking, LLC, Atlanta, GA (US)

(21) Appl. No.: 12/502,346

(22) Filed: Jul. 14, 2009

Related U.S. Application Data
(60) Provisional application No. 61/106,749, filed on Oct. 20, 2008.

(51) Int. Cl. G08B 1/08; G08B 13/14

(52) U.S. Cl. 340/539.13; 340/572.1

(57) ABSTRACT

The present invention provides a device for tracking a mobile or portable asset. A navigation system beacon device (NSBD) is stored in, on or near the asset, and is turned on under the control of an accelerometer in response to movement of the asset. A signal providing the asset's position and or motion information is then transmitted from the NSBD to a user or client optionally by routing the information to and through a central server.

### FIELD OF THE INVENTION

The invention relates in general to a method and system for monitoring and tracking the location and travel pattern of a remote user, vehicle or other asset type. The invention relates particularly to autonomous reporting of asset activity by means of a navigation system beacon device whose outgoing signal is toggled on and off by autonomous means, such as activating during conditions of interest.

### BACKGROUND OF THE INVENTION

Because of the frequency of travel and the growing dependence on information processing devices, in societies around the world both workplaces and their hard assets are increasingly mobile or portable. In many cases the uses, travel and possessory patterns for these assets have become more complex than conventional inventory tracking mechanisms can accommodate. Moreover, conventional security measures are less and less adequate against sophisticated thieves. Thus valuable assets are commonly misused, misplaced and or stolen. The problem is complex at several levels. First, with the proliferation of off-site activity it is hard to monitor the activities of personnel. Also, some types of assets have their most profitable uses only when they remain at a customer site for an extended period: instrument rentals as well as specialized computer placements and earth-moving equipment are in this category. And constant vigilance is required to avoid leaving hand-carried assets behind, moreover third parties have the motivation and ability to use them readily in other contexts: examples include purses, briefcases, video game hardware, laptop computers and other electronic devices.

Cargo theft illustrates many of the issues encountered in managing movable assets. Law enforcement officials report that an estimated 60% of cargo thefts go unreported. The International Cargo Security Council reports that cargo theft costs Americans $60 billion per year, or $205 per person in the U.S. In a single year 30% of the U.S. cargo insurance agents went out of business, and 18 of 24 cargo insurers no longer do business in Florida because of the theft problem. Law enforcement officials have used fax alert systems for such thefts, but these were operative only during business hours. An electronic freight theft management system provided more rapid response, improved legibility, allowed database use around the clock, and reduced investigator workloads. However even the electronic system did not provide real time information on the assets' location, and unless the report contains specific information about the trailer number, license plate, etc., police seldom have enough identifying data to locate the missing items, moreover fraudulently painted DOT numbers have been an ongoing problem. The indirect costs of such thefts may be as much as five times greater than the value of the stolen goods. Those costs include sales lost to stolen goods, extra expense to expedite replacement shipments, costs for processing insurance claims, and increased rates for insurance coverage, In one estimate the indirect cost of cargo thefts is 1% of the U.S. Gross Domestic Product.

Various types of measures have been used to try to track assets with more precision. U.S. Pat. App. Pub. No. 2006/0161345 A1 to Mishima et al. claims a vehicle load control system in which information on the cargo loading condition of a moving vehicle is combined with position information from a GPS and is communicated to a control center.

Int. Pat. App. Pub. No. WO 03/065270 A2 to Degiulo et al. (Accenture, LLP) teaches a tracking system for tracking assets such as freight and incorporating business intelligence. GPS and RFID wireless signaling are combined with a status tracking manager structure unit and a tracking manager unit to provide real time status information about asset movements to clients.

Laid-Open German Pat. App. Pub. No. DE 195 08 684 A1 to Stark discloses a transmitter connected to a GPS receiver, which after activation transmits the positional data received to a central monitoring station. When the GPS receiver and transmitter are hidden at a valuable object to be protected, and when an activator there is activated and thus activates the GPS receiver as well, the system serves as an electronic system protecting valuable objects from unauthorized removal.

Japanese Pat. App. Pub. No. 2001-175983 to Masayuki et al. (NEC Mobile Commun. Ltd.) relates location data of a client on the site of collection/delivery for luggage. The location data are received from a GPS receiver in the collection/delivery of luggage; the client's name and telephone number is read by a voucher-reader from a voucher attached to the luggage. The location and client data are related and edited as link data at a control terminal, are transmitted by radio signal to an operating center, stored and held in a data base, and are read into a PC, and data processing is executed.

U.S. Pat. No. 6,697,103 to Fernandez et al. teaches an integrated combination of GPS tracking with imaging sensors to detect movement for (criminal) surveillance purposes.

U.S. Pat. No. 6,650,999 to Brust et al. teaches a navigation system carried in a mobile terminal by a driver for finding his or her car upon returning to a parking lot; the information concerning the parked car can also be stored in a remote intermediary memory to which the mobile terminal has access.

U.S. Pat. No. 5,418,537 issued to Bird discloses location of missing vehicles by means of installed GPS antenna, signal receiver/processor, paging responder, cellular telephone with associated antenna, and a controller/modem. Vehicles that remain un-found are paged from a service center to interrogate the GPS receiver/processor for the vehicle's present location.

Laid-Open German Pat. App. Pub. No. DE 199 38 951 A1 to Trinkel (Deutsche Telekom AG) discloses a vehicle-finding device, including a GPS receiver and an antenna for the same, a device for computing the direction and or distance to the vehicle, and a device for acoustic, optical and or sensor-motor output especially of the direction and or distance. The device as shown is in the form of a casing for the head of a car key.

U.S. Pat. App. Pub. No. 2006/00087432 A1 to Corbett Jr. teaches the use of an interrogator unit that can receive signals and process information, with the objective of locating personal effects left by travelers in their hotel rooms. The interrogator unit is placed on or in an item of luggage to monitor the presence of items of personal value that are each equipped with an electronic signaling device and RFID tag or GPS chip.

U.S. Pat. App. Pub. No. 2005/0137890 A1 to Bhatt et al. teaches the use of programmable fingerprint scanners to identify and control the movement of suitcases associated with respective individual travelers, for purposes of traveler security.

Examples from the pet industry are also illustrative. Animals such as scent hounds and wandering cats commonly leave their home turf to wander neighborhoods or even go far afield. An emerging product category is tracking devices that can be attached to pet collars. For instance, the RoamEO combines GPS with a 154.60 MHz band to provide transmissions of location information from up to a mile away even in the absence of cell phone coverage. A related RoamEO product displays the pet's exact location, current movements and velocity. Another product uses an electronic base station in the home to activate a collar GPS in the event that it receives no corresponding pet signal from within the home's perimeter. The weight of the early collar electronics was acceptable for dogs but not most cats, though this is changing.

Several problems remain, however. External devices such as GPS-equipped tags may be damaged during handling, moreover they need a clear radio path to satellites. GPS tags and other GPS peripheral devices may also be removed or disabled by thieves, particularly when the devices are bulky enough to attract attention. Constant or frequent data collection and transmissions may drain the batteries of a GPS device before it reaches the destination, especially for long trips and particularly because of the high power requirements of many GPS devices. Moreover, federal regulations would forbid radio-frequency transmissions by GPS for airfreight because of the potential for interference with avionics. And these technologies do not put an owner or possessor on immediate notice if they are misplaced.

Thus there is an ongoing need for solutions that can ensure the security of mobile or portable assets, and enable users to audit and as necessary recover their assets directly using real-time information.

### BRIEF SUMMARY OF THE INVENTION

The present invention provides a device for tracking a mobile or portable asset. A navigation system beacon device (NSBD) is stored in, on or near the asset, and is turned on under the control of an accelerometer in response to movement of the asset. A signal providing the asset's position and or motion information is then transmitted from the NSBD to a user or client optionally by routing the information to and through a central server.

The NSBD has components that can receive a signal bearing position information from a location such as a satellite or ground station or aquatic station. The NSBD then stores and optionally processes information, and when permitted, transmits information. The NSBD's output signal is toggled autonomously under the control of an accelerometer under threshold conditions of velocity or acceleration, and may optionally be toggled off autonomously under conditions of perceived inactivity or low battery charge. When the NSBD is enabled its output signal is transmitted to a user, client or central server continually, periodically or on demand. In the toggled-on mode the NSBD transmits a signal that communicates position information and or information about motion, time and the like. After the information is received at the central server, a client receives a report. The report to the client may be by telephone, email, text message, voice message, transmission to a hand-held navigational device, posted entry at a client-accessible website, or other media. The actual location of the asset may be computed at the NSBD unit, at the central server, or at a navigational device or website accessible to the client, or by some combination of these.

In one embodiment the invention is a method for tracking the location of an asset, comprising:
a) placing a NSBD in close proximity to the asset;
b) receiving at a component of the NSBD a transmission of position information;
c) storing the information or a processed form of it at a component of the NSBD; and
d) transmitting a signal from the NSBD to report position information;
   wherein the NSBD's ability to transmit position information is toggled off under the control of an accelerometer when the asset attains a pre-defined threshold of velocity or g-force, and or the NSBD's ability to transmit position information is toggled off after detection of sustained below-threshold activity, or wherein the toggling on or off of the NSBD's transmission capacity is constrained by a history circuit comprising an accelerometer.

In a second embodiment the invention is a method for tracking the location of an asset, comprising:
a) receiving a transmission of position information from a satellite or ground station at a component of a NSBD that is in close proximity to the asset;
b) storing the information or a processed form of it at a component of the NSBD;
c) optionally calculating the position of the asset based on the information received from the satellite or ground station, wherein the calculation is performed at a component of the NSBD;
d) transmitting a signal from the NSBD to a central server to report position information, but wherein
   i) the NSBD's ability to transmit information is toggled off under the control of an accelerometer when the asset attains a pre-defined threshold of velocity or g-force,
   ii) the NSBD's ability to transmit position information is toggled on after detection of sustained below-threshold activity, and or
   iii) the toggling on or off of the NSBD's transmission capacity is constrained by a history circuit comprising an accelerometer;
e) calculating the position of the asset at a component of the central server based on the position information received by the NSBD from the satellite or ground station, if the position of the asset had not been calculated at a component of the NSBD;
f) transmitting position information from the central server electronically to a client telephone, email address, handheld navigational device or client-accessible web page entry;
wherein position information received at the NSBD is processed to determine the location or optionally velocity or acceleration of the asset, and wherein the determination is by means of a computation at the NSBD, the central server, the handheld navigational device, the client-accessible web page, or a combination thereof.

In another embodiment the invention comprises a self-locating unit comprising an asset in close proximity to a NSBD, wherein the NSBD comprises:
a) a component that can receive transmissions of position information;
b) a component that can store position information;
c) a component that can transmit position information; and
d) one or more accelerometers under the control of which the NSBD's ability to transmit information is toggled on when the asset attains a pre-defined threshold of velocity or g-force, and or the NSBD's ability to transmit position information is toggled off after detection of sustained below-threshold activity, or wherein the toggling on or off of the NSBD's transmission capacity is constrained by a history circuit comprising an accelerometer.

In still another embodiment the invention comprises an integrated system for tracking the location of an asset, comprising:
a) an asset;
b) a navigational beacon system device (NSBD) in close proximity to the asset, wherein the NSBD comprises:
   i) a component that can receive transmissions of position information;
   ii) a component that can store position information;
   iii) a component that can transmit position information; and
   iv) one or more accelerometers under the control of which the NSBD's ability to transmit information is toggled on when the asset attains a pre-defined threshold of velocity or g-force, and or the NSBD's ability to transmit position information is toggled off after detection of sustained below-threshold activity, or wherein the toggling on or off of the NSBD's transmission capacity is constrained by a history circuit comprising an accelerometer;
c) a central server that can receive position information from the NSBD's transmissions and communicate position information to a client; and
d) a means for sending position information electronically to the client from the central server, and or a web site accessible to the client wherein the web site is capable of receiving and displaying asset position information.

### BRIEF DESCRIPTION OF THE DRAWINGS

FIG. 1 is a schematic caricature illustrating one embodiment of an integrated system for tracking an Asset according to the invention.

FIG. 2 is a flow diagram illustrating an embodiment of communication flows in an integrated system according to the invention for tracking an Asset.

FIG. 3 is a schematic caricature illustrating an embodiment of a self-locating unit according to the invention for tracking an Asset.

FIG. 4 is a flow diagram illustrating an embodiment of signal processing in a NSBD whose transmitter toggle switch is activated or deactivated according to the invention.

FIG. 5 is a flow diagram illustrating an embodiment of signal processing in a NSBD whose transmitter toggle switch is activated or deactivated according to navigational information received from a plurality of navigational data sources according to the invention.

FIG. 6 is a flow diagram illustrating an embodiment of signal processing in a NSBD whose transmitter toggle switch is activated or deactivated according to the invention in which the Asset's specific movement data detected under the control of an accelerometer.

FIG. 7 is a flow diagram illustrating an embodiment of tamper detection logic flows in a NSBD whose transmitter toggle switch is activated or deactivated according to the invention in which the Asset's specific movement data is detected under the control of an accelerometer.

### DETAILED DESCRIPTION OF THE INVENTION

The present invention provides a device for tracking persons, vehicles, packages, personal property, portable electronic items, and other valuable assets, wherein the device uses “smart” navigation system technology to locate them. The key component to the smart device is a programmable accelerometer. A navigation system beacon device (NSBD) is stored at, on or near a person, vehicle, package, item of personal property, portable electronic item or other valuable asset, In one embodiment the NSBD is turned on and off respectively by an accelerometer during starting and stopping of the asset's motion, such that the transmitted reporting signal is enabled while the asset is in motion. In another embodiment the transmittal reporting signal is disabled while the asset is in motion. In a further embodiment a signal from the NSBD may be transmitted to a user's or owner's central server, from which the location of the Asset is communicated to a client by an email message, direct message (e.g., via phone, worldwide network or PDA), or posting at a web site that can be accessed by the client. In other embodiments, the client or central server activates the transmission capability for specific type of movement, or specific velocity; and in still other embodiments, the NSBD is activated when it detects hazardous behavior such as hyper-acceleration, swerving, or sharply stopping. The invention relates particularly to autonomous reporting of asset locations and to silencing (i.e., signal off) during conditions not of interest.

### DEFINITIONS

Particular terms recited in this description of the invention have the following meanings. The terms “asset” and “valuable asset” as used herein are synonymous and refer to a subject or object for which tracking of location and mobility is desirable. The following lists of suitable assets are non-exclusive and merely illustrative. Human assets include on-site and off-site people such as young children, teen-age children, students, drivers, other travelers, contractors, employees, vendors, customers, visitors, and the like. Vehicle assets include: ground vehicles such as bicycles, BMX and motocross bikes, motorcycles, all-terrain vehicles, dune buggies, snowmobiles, cars, trucks, limousines, armored cars, armored tanks, and the like; water vehicles such as kayaks, canoes, rafts, row boats, motorboats, speed boats, yachts, ferries, tug boats, tankers, container ships, submarines and other military craft, and the like; air vehicles such as planes, gliders, hang gliders, helicopters, hot air balloons, dirigibles, parachutes, and the like; track vehicles such as trains, trams, trolleys, cable cars, subway cars, sidelined rail cars, roller coaster cars, and the like; transport vehicles such as truck cabs, trailers, flat beds, and other cargo moving equipment; mobile carnival equipment such as merry-go-rounds, ferris wheels, spinning rides, game booths, and the like; front-end loaders and other earth-moving equipment; cranes and other high-rise construction equipment; tar leveling rollers and other highway construction equipment; forklifts and other warehouse equipment; excavation vehicles and other mining equipment; and the like. Hand-carried assets include purses, brief cases, fanny packs, computer bags, backpacks, sample storage kits, and other luggage. Electronic assets include laptop computers, notebook computers, video game hardware, electronic book readers, cell phones, text messaging devices, diagnostic instruments, GPS units, radios, portable music players such as for compact discs or MP3 files, portable movie players such as for DVDs, and the like. The term asset as used herein includes appended items such as identification tags, and when they are attached to the asset includes peripheral items such as wheeled conveyances. The term “item” or “piece” as used herein with respect to assets refers to a single asset or to consolidated assets.

The terms “luggage” and “baggage” as used herein are synonymous and refer to a container for the transport of personal effects or other items during travel, including but not limited to: suitcases; garment bags; duffel bags; footlockers; steamer trunks; equipment cases; lock boxes; shipping boxes; exhibition cases; tool chests; wine cases; tubes for protecting rolled documents; envelopes and cartons for flat documents; flat portfolio cases such are used for artwork; protective cases for musical instruments; crates for transporting pets or other animals; sports gear such as bats, rackets, golf bags, ball bags and the like; wheelchairs and other specialized luggage for disabled patrons; rolling luggage carts and carriers; and so forth. The term luggage as used herein includes appended items such as luggage tags, and when they are attached to the luggage includes peripheral items such as wheeled conveyances. The term luggage as used herein includes carry-on items such as but not limited to purses, briefcases, computer bags, overnight bags, loose garments, and bags and cartons of gifts or souvenirs, as well as luggage stored in the cargo bay of an aircraft. The term “item” or “piece” as used herein with respect to luggage refers to a unit of luggage.

The terms “tracking” and “monitoring” are used synonymously herein, and refer to identifying the location or movement pattern of an asset item. The term “position” or “location” as used herein with respect to an asset are synonymous and refer to navigational position, i.e., geographic position.

The term “self-locating” as used herein refers to autonomous detection and optionally transmission of position information that is relevant to characterizing an asset's location or movement. In particular the term self-locating is used here in with respect to NSBDs and motion features that are tracked by means of NSBDs. The term “self-locating unit” as used herein refers to a device, system or ensemble comprising an asset in close proximity to a NSBD.

The term “navigation system beacon device” (NSBD) as used herein refers to a device that is capable of receiving signals electronically, storing data received from such signals and or data processed from such signals, transmitting a signal, and having at least its transmission capacity toggled off and or on—and or constrained from being toggled off and or on—by a switch in response to a threshold accelerometer value and optionally time value.

The term “component” as used herein with respect to an NSBD according to the invention refers to a functional unit or circuit feature including but not limited to a mechanical sensor, circuit board, computer processing unit, designated memory space, or other identifiable component in a computer circuit for performing the respective function. Functions of such components may include but are not limited to detecting or measuring a physical parameter such as, for example, acceleration or speed; receiving; storing; transmitting; computing; switching or the like. When in use an NSBD comprises or is in electrical connection with a power source such as a battery, hardwired electrical outlet, fuel cell, super capacitor, electrochemical capacitor, induction coil, generator, solar collector, self-winding mechanism, or other power supply.

The term “close proximity” as used herein with respect to an asset item refers to use of a device according to the invention in a manner and at a positioning that is sensitive to the motion actually experienced by the vehicle or rider. For an NSBD this may be a freestanding position inside the item, an attached position inside the item, an attached position outside the item, or a location within an integral part of the asset itself. Thus in non-exclusive illustrative embodiments, an NSBD according to the invention may be handheld; or worn as a pin, bracelet, chain, ring, patch, or item of clothing; or carried in a pocket, pouch or purse; or worn on a wrist strap or belt, or attached to the interior or exterior of the asset; or housed in a compartment of the asset; or affixed as an integral component of the asset; or free-standing.

The term “operating equipment of a vehicle” as used herein refers to equipment of a vehicle for which an NSBD may be attached, in electrical communication, or powered by.

The terms “mobile” and “portable” as used herein with respect to devices according to the present invention refer to a unit that may, e.g., be handheld, however it would not depart from the spirit of the invention to affix a mobile or portable unit permanently, e.g., to a vehicle.

The term “position information” as used herein refers to information about the location of a NDSB. The term may refer to the coordinates or geographic location of the NSBD relative to navigational devices such as satellites or other stations broadcasting navigational information, its time relative to such navigational broadcast stations, its relative distance from a RFID device, and or its altitude. The terms “position” and “location” are used interchangeably herein.

parameters of movement; illustrative parameters include the velocity, acceleration, path, angle, torque, and the like. The term “motion” as used herein with respect to an asset refers to movement of the asset and to position or change of position of the asset relative to the motion. The term may optionally include the asset's angle of inclination relative to the motion, lateral angle during the movement, as well as twist, torque, acceleration, deceleration, response to centrifugal force, and so forth.

The terms “measuring” and “determining” as used herein refer generally to measurement of a physical property of motion, distance or location unless the context indicates otherwise. The term “assessing” as used herein refers to measuring, or to evaluating their characteristics by either objectively or subjectively programmed criteria.

The term “processed” as used herein with respect to information refers to data that has been converted by one or more steps for the purpose of determining a characteristic of position or motion.

The terms “storing” and “logging” as used herein with respect to position or motion information under the invention refers to storing such information temporarily or permanently; this includes but is not limited to use on electronic media. The terms optionally include storing of relevant information that has been processed or transformed for useful reporting to a user. The terms include but are not limited to storing information about events in their chronological order of occurrence.

The terms “report” and “reporting” as used herein with respect to position and motion information under the invention refers to providing such information to a user, optionally in revised or calculated form, such as by calculating asset location from triangulation of relative satellite locations. Reporting optionally includes transmission of such information to a remote location as, e.g., to a central server, website, or personal telecommunication device. The term “periodic” as used herein with respect to reporting refers to reporting on a prescheduled basis, e.g., at certain points during the day. As used herein, reporting in response to a query refers to reporting after a specific contact by a user or third party. As used herein, reporting under the control of an accelerometer refers to reporting information in response to observation of a threshold value in one or more physical characteristics of motion; the reporting criteria may be pre-programmed by the device's maker, or entered by a user or client. As the term is used herein, reporting may be by visual display, auditory announcement, transfer of information bits by telephonic landline, wireless transmission of raw or processed data, or other form of data communication.

The term “self-locating” as used herein refers to autonomous detection and transmission of position information that is relevant to remote identification of the location of the self-locating unit. In particular the term self-locating is used here in with respect to NSBD's and assets that are tracked by means of NSBD's.

The term “pre-defined threshold” as used herein with respect to velocity, g-force, or another parameter of motion or position refers to a threshold value either hard-wired, intrinsically coded, or entered by a user into an NSBD, above or below which value at least one function of the device is autonomously toggled on or off, not necessarily respectively. The term “pre-defined threshold” as used herein with respect to a power source refers to a putative capacity below which a discharged or near-discharged condition is indicated.

The term “sustained below-threshold activity” as used herein refers to activity that falls below a pre-defined threshold for a sufficiently long period to trigger autonomous deactivation of at least one function in an NSBD. The period may optionally be selected as the device default value or as a user-defined period.

The term “electronic communication” as used herein with respect to signals refers to the communication of information by means of electronic media. The term “directed electronic communication” refers to a message to a particular user as by a telephone call, email, instant messaging, text messaging, paging, or other electronic message to a particular user of the device according to the invention. The term “communications device” as used herein refers to a device for transmitting and or receiving directed electronic communications.

The term “in electrical communication” and like terms as used herein refer to the existence of a path for electrical current to flow between one referenced device component and another referenced device component.

The term “central server” as used herein refers to a device that receives and sorts and or processes electronic information for distribution to a client. The central server may be a computer of a commercial asset-tracking service, or may for instance be nothing more than a router or switchboard for sorting and relaying emails or wireless telephone calls. The central server may be operated by a user, a client, a vendor, or another party, thus the term central server as used herein does not in itself indicate a particular type of operator.

The term “vendor” as used herein refers to a party who provides a service for the collection, processing or distribution of information transmitted from a NSBD.

The term “client” as used herein refers to a person who is tracking or monitoring a ride and receives or accesses information from a NSBD or by means a central server. The term client as used herein includes but is not limited to personal users, as well as professional users who employ the data for monitoring or feedback, or for data mining of a marketing demographic.

The terms “telephone”, “email”, “text message” and “web page” as used herein have their respective normal and customary meanings. The term “client-accessible” as used herein with respect to a web page refers to publicly accessible web pages and also to web pages that are accessible to clients upon providing a security code.

The term “toggle” as used herein refers to activating or deactivating one or more functions of an NSBD.

The term “accelerometer” as used herein refers to a device for sensing acceleration or deceleration, and has its usual and ordinary use in physics and engineering. The term “accelerometric” as used herein refers to the capacity of a device to detect such acceleration or deceleration.

The terms “under the control of an accelerometer,” “under the control of a circuit containing an accelerometer,” “under the control of a circuit comprising an accelerometer,” and like terms refer to a circuit for which a component or function is activated or deactivated directly or indirectly by the response of an accelerometer to detected levels of acceleration and or deceleration. As used herein the terms defined in this paragraph may optionally refer to reporting of information, transmission, computing values, and other functions of circuits. As used herein, non-exclusive examples of types of reporting under the control include: controlled continuous reporting of information; reporting for a detected or computed threshold level of acceleration or deceleration; reporting in response to a threshold end velocity such as where the acceleration or deceleration is determined over a specific time; and reporting in response to another physical parameter that can be determined with the aid of an accelerometer. As used herein these defined terms include but are not limited to embodiments in which a switch for a NSBD comprises a plurality of independent alternative means to measure a threshold level of velocity or other physical parameter, wherein at least one of those alternative independent means comprises an accelerometer.

The term “chronometer” as used herein refers to a device for gauging the passage of time, and in an embodiment herein is used in contemplation of relating a sequence of events and calculating speeds and distances in light of acceleration data over time.

The term “physical characteristic” as used herein with respect to motion and the invention refers to a measurable physical parameter such as acceleration (positive or negative), velocity, momentum in the direction of travel, angular momentum, position, torque, or another objective physical characteristic of an asset's motion. As used herein these subordinate terms have their usual and ordinary meaning in physics.

The terms “history,” “motion history,” and “cumulative history” as used herein refer to a cumulative record of one or more physical characteristics of motion.

The term “history circuit” as used herein” refers to a circuit for a device according to the invention, in which the circuit is capable of logging and storing information about a sequence of motions and or positions in a ride event.

The term “constrains” or “constraint” as used herein with respect to a history circuit and toggling refers to the use of a history circuit in an electronic switch that can toggle a NSBD on or off autonomously in response to a threshold value for a physical parameter.

The term “override” as used herein refers to a manual or remote reversal of the activation status for an NSBD transmitter, i.e., toggling on or off in a manner contrary to the autonomous position dictated by an accelerometer or history circuit that normally governs the on/off mode.

The term “takeoff” as used herein refers to the departure phase of an aircraft from the ground at the outset of a flight. The term “landing” as used herein refers to the return phase of an aircraft to the ground at the end of a flight. The term “lift-off” as used herein refers to the vertical lifting of an aircraft during takeoff. The term “aircraft” as used herein refers without limit to aircraft that carry passengers, especially commercial aircraft, and includes airplanes, helicopters, balloons such as blimps, and other aircraft such as are familiar to those of ordinary skill in the art of commercial flight.

The term “navigation system” refers to a system for broadcasting geographic and or navigational position information from discrete sites or equipment.

The term “navigational circuit” as used herein refers to a circuit for a device according to the invention, in which the circuit is capable of determining relative position from a known starting point and internally acquired information, as for an inertial navigation system, or of receiving position input data from a user or from an external source such as a navigational beacon, and processing such information to calculate position to track the path of motion.

The term “navigational beacon” as used herein refers to a navigational beacon such as a global positioning satellite, navigation ground stations for navigation broadcasts, and or marine navigation broadcast station. These terms refer to beacons from which a NSBD may receive transmitted position information. The term “externally obtained navigational information” refers to information transmitted from one of these beacons and received by a NSBD or by a source that transfers it to the NSBD.

The term “satellite” as used herein refers to a navigation satellite such as but not limited to a satellite in the artificial constellation of the GPS system. The terms “ground station” and “aquatic station” as used herein refer to navigational broadcast stations that are based on land or a body of water, respectively.

The term “hand-held navigational device” as used herein refers to a position-finding device such as a consumer GPS device or comparable device.

The terms “geo-positioning satellite,” “GPS,” and “assisted GPS,” as used herein have their ordinary and common meanings in the field of navigational technology, and also their meaning as used by consumers to refer to portable GPS devices.

The term “inertial navigational system” and “INS” as used herein are synonymous and have their ordinary and common meaning in the field of navigational technology. The term GPS-INS refers to a device or circuit that links or combines GPS and INS capabilities.

The terms “radio frequency identification,” “RFID,” “dedicated short range communication,” and “DSRC,” as used herein are synonymous, and have their usual and ordinary meaning, i.e., they refer to electromagnetic or electrostatic coupling in the radio frequency portion of the electromagnetic spectrum to acquire or transmit identification information.

The terms “under the control of RFID” and like terms as used herein refer to toggling a circuit component on or off in response to an RFID signal, such as for activating or deactivating a detection component, navigational component, computational component, storage component, transmission component, or other component of a circuit for a device according to the invention.

The term “migration” as used herein with respect to an asset refers to its relocation from one place to another.

The term “potentially unauthorized removal” as used herein with respect to assets refers to a condition under which an asset is put into motion and taken to a distance that is outside the respective NSBD's default or programmed use conditions, and for which no override command has been entered at the NSBD or at a control station such as the central server and no impropriety has been confirmed yet. An alert for potentially unauthorized removal may occur in the event of theft of a NSBD-protected asset by a third party. An alert may alternatively occur in the event that a party authorized to use the asset exceeds the scope of use for which authorization had been given, with or without intent. The alert may also occur where an authorized party does not provide the necessary override command for use outside the default boundaries. The last condition may apply, for instance, where an authorized party has been kidnapped to a location outside the authorized area, and while there deliberately omits to override the NSBD's discretionary boundary defaults, thus triggering an automatic silent transmission that alerts others remotely while avoiding any action that might attract harmful attention from captors. An alert for a potentially unauthorized removal may optionally be sustained until the respective asset is located, recovered, or confirmed to remain under authorized possession. The term “potentially tampered” as used herein with respect to the status of an asset refers to a status in which the movement or g-force history meets or exceeds pre-defined threshold conditions for transmitting a notification or alarm signal to a user, client or central server, but wherein the impropriety of the asset's movement or use has not yet been confirmed.

The term “integrated system” as used herein with respect to the invention refers to a network of devices for receiving, processing and or reporting information in conjunction with an NSBD.

The term “g-force” as used herein refers to the acceleration of an object relative to free-fall. As is typical in the art, the unit of measure g (also G), where for a stationary object on earth 1 g is equivalent to standard gravity (gₙ), 9.80665 meters per square second, an object has 0 g in a weightless environment such as free-fall or an orbiting satellite, and g-forces exceed 1 g on, for instance, accelerating rockets and roller coasters.

The term “altimeter” as used herein refers to an instrument for measuring altitude above a fixed level, generally sea level. It is to be understood that an altimeter measures altitude indirectly, based on atmospheric (i.e., barometric) pressure, thus its accuracy is weather-sensitive.

The term “speedometer” as used herein has its usual and ordinary meaning of a device that measures the instantaneous speed of a land vehicle or object. Where geo-positioning satellite information is used to calculate velocity herein, that will be indicated.

The term “odometer” as used herein has its usual and ordinary meaning and is synonymous with the colloquial terms mileometer or milometer: it indicates is a mechanical or electronic device for indicating distance traveled by an automobile or other vehicle.

### Navigation Guidance Systems

Global Positioning Satellite (GPS) and similar small electronic receivers are capable of assessing speed based on change in position between measurements (usually taken at one-second intervals). As the GPS is a triangulation system, its speed calculations depend on the positional accuracy and beacon signal quality. Speed calculations are more accurate at higher speeds, when the ratio of positional error to positional change is lower. GPS software may also use a moving average calculation to reduce error. An advanced Global Positioning Satellite (GPS) receiver (GPSr) with an odometer mode serves as a very accurate pedometer for outdoor activities. While not truly counting steps (no pendulum is involved) an advanced GPSr odometer can reveal the accurate distance traveled to within 1/100th of a mile (depending on the model, even 1/1000th of a mile), or approximately the distance of two steps. A GPSr with odometer mode is an excellent and inexpensive means to track speeds on motion cycles that last more than a few seconds.

GPS units are typical of navigational system user hardware; as usual, the receiver includes the following:
an antenna;
receiver-processors;
a highly stable clock such as a crystal oscillator;
optionally an information display for the user;
between 12 and 20 channels in contemporary models, corresponding to the number of satellites that they can monitor simultaneously;
optionally an input for differential locations, such as the RTCM SC-104 format, internal DGPS format, or Wide Area Augmentation System Receiver;
hardware for relaying position data to a PC or other device, such as by the US-based National Marine Electronics Association (NMEA) 0183 or 2000 protocol, or such as the SiRF or MTK protocol; and
optionally an interface for other device such as a serial connection, USB or Bluetooth.

GPS receivers are small enough to fit into phones and watches, and for instance a SiRFstar III receiver and integrated antenna from the Antenova company (UK) has dimensions 49×9×4 mm, which is about the size of a small, wafer-thin computer keyboard.

GPS and similar devices rely on navigation guidance systems, broadly known as the global navigation satellite system (GNSS), for systems having autonomous geo-spatial positioning with global coverage. Stationary ground receivers can also be used to calculate precise time. The U.S. NAVSTAR Global Positioning System (GPS) was the first fully functional operational GNSS, based on 31 Medium Earth Orbit satellites (about 20,200 km above the earth) in non-uniform orbits; each satellite transmits precise microwave signals, and at least six satellites are within the line of sight for almost every place on the earth's surface. Other systems are under development, including the Russian GLONASS and the European Union's Galileo. Regional satellite navigation systems include China's Beidou navigation system titled “Compass” based on 30 Medium Earth Orbit satellites and five geostationary satellites, India's IRNSS under development, and Japan's QZSS system.

GNSS-1 is the first generation and includes satellite- and ground-based augmentation (SBAS and GBAS, respectively) such as the Wide Area Augmentation System (WAAS, U.S.), European Geostationary Navigation Overlay System (EGNOS), Multi-Functional Satellite Augmentation System (MSAS, Japan) and GAGAN (India). GBAS examples include the Local Area Augmentation System (LAAS), regional CORS networks, Australian GRAS, and U.S. Department of Transportation National Differential GPS (DGPS) service, as well as local GBAS using single GPS reference station Real Time Kinematic (RTK) corrections. GNSS-2 is for independent civilian navigation (e.g., Galileo, Europe): L1 and L2 frequencies are for civil use and L5 for system integrity; it will adopt the same frequency assignments as GPS.

Each GNSS satellite transmits its position in a data message superimposed on a code that serves as a timing reference, and an atomic clock synchronizes timing for all satellites in a network. The signal's time-of-flight is calculated by subtracting encoded transmission time from reception time. When several such measurements are made at the same time relative to different satellites, the GNSS allows determination of a continual fix on position in real time, essentially by triangulation. For fast-moving receivers the change in distance and reception angle affects calculations. The computation seeks the shortest directed line tangent to four oblate spherical shells centered on four satellites. Combining signals from more satellites and correlators reduces error; methods such as Kalman filtering provide a single estimate for position, time, and velocity. The calculated location is then translated into a specific coordinate system such as latitude/longitude using the WGS 84 geodetic datum or a country-specific system.

Each GPS satellite continuously broadcasts a navigation message at 50 bit/s, in 30-second frames of 1500 bits each; the code is unique to each satellite so all can use the same frequency. The opening (6 seconds) provides time of day, GPS week number and satellite health data; the second part (12 more seconds) is an ephemeris with the satellite's precise orbit, updated every 2 hours and generally valid for twice that; and the closing is an almanac (12 seconds: coarse orbit and status data for each satellite in the constellation) but the almanac is only provided in increments of 1/25, so 12.5 minutes are required to receive the entire almanac. The almanac standardizes time, corrects for ionosphere error, and facilitates receiver focus on visible satellites, though that is less necessary in newer GPS hardware. Satellites are designated unhealthy when their orbits are being corrected, then designated healthy again.

Errors arise from several sources. Ionospheric effects introduce +5-meter error. Ephemeris effects introduce +2.5-meter error. Satellite clock errors effects introduce +2-meter error. Multipath distortion introduces +1-meter error, as do numerical errors. Tropospheric effects introduce +0.5-meter error. Relativity, Sagnac distortion, and other sources can also cause small errors. Autonomous civilian GPS horizontal position fixes are accurate to about 15 meters (50 feet); high frequency P(Y) signal results are accurate to about 1.5 meters (5 feet). A currently disabled feature in GPS, Selective Availability (SA), introduced random errors of up to 10 meters horizontally and 30 meters vertically in C/A. Interference from solar flares, windshield metal, malfunctioning television preamplifier, etc., can also cause errors or weaken signals. Some errors are minimized by resolving uncertainty in signal phase differences, as in Carrier-Phase Enhancement (CPGPS). Another approach resolves cycle numbers in which signal is transmitted and received, using differential GPS (DGPS) correction data, as in Relative Kinematic Positioning (RKP) statistically with Real-Time Kinematic Positioning (RTKP).

GNSS Augmentation incorporates external information to improve accuracy, availability, or reliability of satellite broadcasts. Some systems correct for error sources such as clock drift, ephemeris, or ionospheric delay. Others measure the signal's error history. Still others provide supplemental navigational or vehicle data. Augmentation systems include the WAAS, EGNOS, MSAS, Differential GPS, and Inertial Navigational Systems.

Assisted GPS (A-GPS or aGPS) was introduced to enhance conventional GPS for cell phones; and expedited under the U.S. Federal Commerce Commission's E911 mandate to make cell phone positions available to emergency call dispatchers. It addresses problems with weak reception, signal reflection, multipath echo effects, and barriers to signal. Powering up in unfavorable conditions, some non-A-GPS units require up to a minute of clear signal to download the almanac and ephemeris information from GPS satellites.

A-GPS receivers locate a phone approximately in its cellular network using an Assistance Server to compare fragmentary cell signals with direct satellite signal; they supply orbital data for GPS satellites to a cell phone to enable locking on to the satellite signal, and provide more complete data about ionospheric conditions than the phone contains. Some but not all A-GPS solutions require active connection to a communications network. Because the assistance server does so much computation, CPU and programming requirements in A-GPS phones can be small.

High Sensitivity GPS is similar to A-GPS, addressing some of the same issues that do not require additional infrastructure, except that it cannot provide instant fixes on satellite positions when the phone has been off for some time.

Enhanced GPS (or eGPS) compares favorably with A-GPS, and was developed by CSR and Motorola for an open industry forum for mobile phones, exploiting cellular network data on GSM/W-CDMA networks. It provides faster location fixes, better reception, lower cost and lower power and processing requirements. E-GPS combines CSR's “Matrix” technology to locate the user instantly to 100 meter accuracy based on cell tower information. CSR's “Fine Time Aiding” then guides the device search for a GPS signal, to acquire satellite data within seconds. This is said to be equivalent to 6 dB more sensitivity than achieved by any GPS hardware correlator in the terminal. Other GPS uses for monitoring moving carriers include the following.

U.S. Pat. App. Pub. No. 2006/0161345 A1 to Mishima et al. claims a vehicle load control system in which information on the cargo loading condition of a moving vehicle is combined with position information from a GPS and is communicated to a control center.

U.S. Pat. App. Pub. No. 2005/0197755 A1 to Knowlton et al. discloses a method to determine the position and orientation of work machines such as excavators, shovels and backhoes by two- and three-dimensional GPS in combination with inertial sensors to calculate pitch and roll from linear accelerations.

Laid-Open German Pat. App. Pub. No. DE 199 38 951 A1 to Trinkel (Deutsche Telekom AG) discloses a vehicle-finding device, depicted in the form of a casing for the head of a car key, which includes a GPS receiver and an antenna for the same, a device for computing the direction and or distance to the vehicle, and a device for acoustic, optical and or sensor-motor output especially of the direction and or distance.

In one embodiment of the present invention the NSBD receives navigational information from any of the above-described current navigational guidance systems. In a further embodiment of the invention the NSBD receives navigational information from a GNSS. In a particular embodiment of the invention the NSBD receives navigational information from a GNSS-1 system. In another embodiment of the invention the NSBD receives navigational information from a GNSS-2 system. In yet another embodiment of the invention the NSBD receives navigational information from a ground-based station. In still another embodiment of the invention the NSBD receives navigational information from an aquatic-based station. In a further embodiment of the invention the NSBD receives navigational data from a GPS satellite. In another embodiment the NSBD receives navigational data from an A-GPS transmitter.

In a further embodiment the NSBD tracks and reports one or more path parameters such as locations of the rider, the distance traveled, loops and related features in the path as determined by means of a navigational circuit in the NSBD.

### Accelerometers

An accelerometer is a device for measuring reaction forces that are generated by acceleration and or gravity; accelerometers designed for measuring gravity alone are known as gravimeters. Accelerometers can be used to sense inclination, vibration, and shock. Both acceleration and gravity are typically measured in terms of g-force (m/s²), where 1 g=ca. 9.8 m/s² (ca. 32 ft/s²). Single- and multi-axis models are available to detect magnitude and direction of the acceleration as a vector quantity. Under Einstein's equivalence principle the effects of gravity and acceleration are indistinguishable, thus acceleration can be measured alone only by subtracting local gravity from an accelerometer's output of raw data, otherwise an accelerometer at rest on the earth's surface will measure 1 g along the vertical axis. Horizontally, the device yields acceleration directly, but the device's output will zero during free fall in space (a relative vacuum), when the acceleration is identical to that of gravity. For a free fall in earth's atmosphere the device zeros only when terminal velocity (1 g) is reached, due to drag forces arising from air resistance. For inertial navigation systems, vertical corrections for gravity are usually made automatically, e.g., by calibrating the device while at rest. For the sake of reference, it is noted here that Formula One race car drivers usually experience 5 g while braking, 2 g while accelerating, and 4 to 6 g while cornering, and that most roller coasters do not much exceed 3 g but a few are twice that. As noted above, comfort ranges for rides extend to positive 6 g in the direction in which rider are seated, usually −1.5 to −2.0 g design limit for momentary weightlessness, and lateral g forces of up to the range of 1.5 g, though 1.8 g.

A typical automobile acceleration from 0 to 60 mph in 13 seconds represents a constant acceleration rate of about 0.20 g over a distance of no more than a few hundred feet. The following table illustrates g-force ranges that riders commonly experience in road vehicles.

Automotive Acceleration (g)

Vehicle:

| | Typical | Sports | Formula 1 | Large |
|---|---|---|---|---|
| Event: | Car | Car | Race Car | Truck |
| Starting | 0.3 to 0.5 | >0.9 | 1.7 | <0.2 |
| Stopping | 0.8 to 1.0 | >1.3 | 2 | ca. 0.6 |
| Cornering | 0.6 to 1.0 | >2.5 | 3 | ca. 0.5 |

To put these into perspective, other acceleration events in the body tend to be larger, such as a sneeze (2.9 g), cough (3.5 g), jostling in a crowd (3.6), back slap (4.1 g), hopping off a step (8.1 g), casting oneself into a chair (10.1 g), or acceleration of the chest at 30 m.p.h. with an airbag (60 g). Crashes can produce body forces in the range of 70-100 g (high speed fatal crashes) or even 150-200 g (head acceleration during bicycle crash while wearing a helmet). Passenger airplane take-offs are at about 0.2 g, landings are in the range of 0.7 g to 1.5 g, and lateral acceleration rarely exceeds 0.2 g. The difference in g-forces between starting and stopping also provides one basis for accelerometric distinctions between the two events. Swerving and jarring g-forces provide a basis for distinctions between acceptable and suspect activity of a vehicle. Moreover, the number of g's is affected by location in a vehicle. For instance, cars may experience more g's at an axel because jarring by rough roads is not buffered by a shock absorber there. And boats have more g's at the top of a mast because the pitching motion pitching is greatest there.

In recent times accelerometers commonly have been very simple micro electro-mechanical systems MEMS. In a popular format they are little more than a cantilever beam with a proof mass (also called a seismic mass) and some type of deflection-sensing circuitry for analog or digital measurements. Under the influence of gravity or acceleration the proof mass deflects from its neutral position. Another type of MEMS-based accelerometer has a small heater at the bottom of a very small dome; the heater heats the air, which subsequently rises inside the dome. A thermocouple on the dome determines where the heated air migrates to the dome, and the deflection off the center is a measure of the acceleration applied to the sensor.

In a common application, accelerometers are used to calculate the degree of vehicle acceleration and deceleration. In an automobile that enables performance evaluation of both the engine/drive train and braking systems. Common ranges for that purpose include 0-60 mph, 60-0 mph and ¼ mile times, such as in wireless dashboard-mounted devices from Tazzo Motorsports and G-Tech. Accelerometers are also used in flight, for instance to detect apogee in rocketry. A 3-axis range of movement can be detected by using a digital accelerometer. This accelerometer detects movement in these three particular axis by sensing small voltage changes that occur in the accelerometer during movement in each of the three axis. A combination of three accelerometers, or two accelerometers and a gyroscope, are also used in aircraft inertial guidance systems. In an alternative an accelerometer in a spherical housing would swivel or “float” within a socket having a smooth and relatively frictionless inverse spherical interior for receiving the accelerometer, however the device will measure only acceleration in the direction(s) of force, unless the swiveling component's changes in orientation within the socket are tracked and correlated as by an electric eye or other sensor.

In more mundane commercial applications accelerometers have been used to measure vibration on vehicles, work machines, buildings, process control systems and safety installations. For instance, MEMS accelerometers are used in automotive airbag deployment systems; their widespread use in these systems has driven down the cost of such accelerometers dramatically. Accelerometers have also been used scientifically to measure seismic activity, inclination, machine vibration, dynamic distance and speed with or without the influence of gravity.

Recently accelerometers have also found use in enhanced measurements of user motion. For instance, accelerometers have been used in step counting (e.g., like a pedometer); thus Nike, Polar, Nokia and others have sold sports watches in which accelerometers help determine the speed and distance of a runner wearing such a watch. The Wii remote game console contains three accelerometers to sense three dimensions of movement and tilt to complement its pointer functionality, facilitating realistic interaction between a virtual avatar and manual movements of the user during sport-like games.

Recent developments also include the use of accelerometers in digital interface control. Since 2005, Apple's laptops have featured an accelerometer known as Sudden Motion Sensor to protect against hard disk crashes in the event of a shock. Smart phones and personal digital assistants (such as Apple's iPhone and iPod Touch and the Nokia N95) contain accelerometers for user interface control, e.g., switching between portrait and landscape modes, and for recognizing other tilting of the device. Nokia and Sony Erickson also employ accelerometers to detect tapping or shaking, for purposes of toggling features on a consumer electronic device.

Examples of various types of accelerometers and some commercial sources for them are shown below. Single-axis, dual-axis, and triple-axis models exist to measure acceleration as a vector quantity or as just one or more of a vector's components. In addition, MEMS accelerometers are available in a wide variety of measuring ranges, even to thousands of g's.

The following list of accelerometer types includes representative designs and sources for accelerometer devices.
Accelerometer data logger—Reference LLC
Bulk Micromachined Capacitive—VTI Technologies, Colibrys
Bulk Micromachined Piezo Resistive
Capacitive Spring Mass Based—Rieker Inc
DC Response—PCB Piezotronics
Electromechanical Servo (Servo Force Balance)
High Gravity—Connection Technology Center
High Temperature—PCB Piezotronics, Connection Technology Center
Laser accelerometer
4-20 mA Loop Power—PCB Piezotronics, Connection Technology Center
Low Frequency—PCB Piezotronics, Connection Technology Center
Magnetic induction
Modally Tuned Impact Hammers—PCB Piezotronics, IMI Sensors
Null-balance
Optical
Pendulating Integrating Gyroscopic Accelerometer (PIGA).
Piezo-film or piezoelectric sensor—PCB Piezotronics, IMI Sensors
Resonance
Seat Pad Accelerometers—PCB Piezotronics, Larson Davis
Shear Mode Accelerometer—PCB Piezotronics, IMI Sensors, Connection Technology Center
Strain gauge—PCB Piezotronics
Surface acoustic wave (SAW)
Surface Micromachined Capacitive (MEMS)—Analog Devices, Freescale, Honeywell, PCB Piezotronics, Systron Donner Inertial (BEI)
Thermal (submicrometer CMOS process)—MEMSIC
Triaxial—PCB Piezotronics, Connection Technology Center

Additional sources of suitable acceleration switches for use with the present device include the following: Select Controls, Inc. (Bohemia, N.Y.); Inertia Switch, Inc. (Orangeburg, N.Y.); Aerodyne Controls, A Circor International Company (Ronkonkoma, N.Y.); Honeywell Sensing and Control (Golden Valley, Minn.); Measurement Specialties, Inc. (Hampton, Va.); Masline Electronics, Inc. (Rochester, N.Y.); Allied International (Bedford Hills, N.Y.); Jo-Kell, Inc. (Chesapeake, Va.); D′Ambrogi Co. (Dallas, Tex.); Impact Register, Inc. (Largo, Fla.); Hubbell Industrial Controls, Inc. (Archdale, N.C.); Comus International (Clifton, N.J.); and Milli-Switch Corp. (Bridgeport, Pa.).

### Inertial Navigation Systems

Methods by which accelerometers are used to track direction and angle include their use in an inertial navigation system (INS). The INS employs a computer and motion sensors—particularly a combination of accelerometers and optionally a device such as gyroscope—to continuously track the position, orientation, and velocity (direction and speed of movement) of a vehicle without the need for external references. Other names for these and related devices include inertial guidance system, inertial reference platform, and similar appellations. The initial position and velocity is provided from another source such as a human operator, GPS satellite receiver, etc., and thereafter computes its own updated position and velocity based on data from its motion sensors. The advantage of an INS is that it requires no external references when determining its position, orientation, or velocity after receiving the initial external data. Unlike navigation systems that rely on external radiofrequency beacons, it is immune to jamming or accidental radio interference. It can also continue to recognize its own location even when radio contact is broken off, such as inside a canyon, an enclosed or partially indoor roller coaster ride or an airport terminal.

An INS can detect a change in its velocity, orientation (rotation about an axis) and geographic direction (vector) by measuring the linear and angular accelerations. The orientation is determined by gyroscopes, which measure the angular velocity of the system in the inertial reference frame much as a passenger can feel the tilt of a plane in flight. Accelerometers measure the linear acceleration of the system in the inertial reference frame, but only in directions that can be measured relative to the moving system, much as passengers may experience pressure forcing them into their seats during take-off. By tracking a combination of the linear and angular acceleration, the change relative to the inertial reference frame may be calculated. Integrating the inertial accelerations with the original velocity as the initial condition in appropriate kinematic equations yields the inertial velocities of the system. Integrating again with the original position as the initial condition yields the inertial position. INS was originally developed for rockets and employed rudimentary gyroscopes, but today is commonly used in commercial aircraft and other transportation vehicles.

All INSs suffer from integration drift that arises from the aggregation of small errors in measurement that is inherent in every open loop control system. The inaccuracy of a high-quality INS is normally less than 0.6 nautical mph in position, tenths of a degree per hour in orientation. Output errors may be an order of magnitude greater for INS alone than for GPS alone. Combining INS output data with output data from another navigation system such as a GPS system can minimize and stabilize drift in position and velocity computations for either or both systems. The location determined by a GPS system can be updated every half-minute, thus when GPS signal is accessible a logic circuit can essentially eliminates the drift arising from INS. In complementary fashion, the INS provides ongoing position information when the observer is in a location where GPS signals cannot be received. The inertial system provides short-term data, while the satellite system corrects accumulated errors of the inertial system. In fact, INS is now usually combined with satellite navigation systems through a digital filtering system, such as by utilizing control theory or Kalman filtering. The INS can also be re-calibrated during terrestrial use by holding it at a fixed location at zero velocity.

INSs have both angular and linear accelerometers for changes in position; some include a gyroscopic element for maintaining an absolute angular reference. Angular accelerometers measure how the vehicle is rotating in space. Using aircraft guidance systems as an example, generally, there is at least one sensor for each of the three axes: pitch (nose up and down), yaw (nose left and right) and roll (clockwise or counter-clockwise from the cockpit). There is typically a linear accelerometers to measure motion in space along each of three axes (vertical, lateral, and direction of travel). A computer continually updates the vehicle's current position. First, for each of the six degrees of freedom (x, y, z, θx, θy, and θz), it integrates the sensed amount of acceleration over time to compute the current velocity. Then it integrates the velocity to compute the current position. In addition, an inertial guidance system that will operate near the earth's surface must incorporate Schuler tuning so its platform will continue pointing towards the earth's center during movement of the vessel.

The relative cost and complexity of INS designs affect the choice of which systems are most practical for use in the current invention, however with the ongoing deflation of prices for electronic devices various INS designs are increasingly practical and some are already within an appropriate range. Illustrative examples of INS systems in the current art that are technically suitable for use with the invention include the following.

Gimballed gyrostabilized platforms have linear accelerometers on a gimbaled gyrostabilized platform. The gimbals are a set of three rings, each with a pair of bearings initially at right angles to let the platform twist about any rotational axis. Usually the platform has two gyroscopes at right angles so as to cancel gyroscopic precession, the tendency of a gyroscope to twist at right angles to an input force. This system allows a vehicle's roll, pitch, and yaw angles to be measured directly at the bearings of the gimbals. Relatively simple electronic circuits can be used to add up the linear accelerations, because the directions of the linear accelerometers do not change. Expense, wear, potential to jam (mechanically), and gimbal lock are among the drawbacks of these systems.

Fluid-suspended gyrostabilized platforms use fluid (i.e., helium or oil) bearings or a flotation chamber to mount a gyrostabilized platform, usually there are four bearing pads in a tetrahedral arrangement in spherical shell. These systems can have very high precisions (e.g. Advanced Inertial Reference Sphere), and like all gyrostabilized platforms, they run well with relatively slow, low-power computers. Low end systems use bar codes to sense orientation, and may be powered by a solar cell or single transformer. High-end systems employ angular sensors composed of a strip of transformer coils on a printed circuit board, in combination with transformers outside the sphere, to measure (induction-based) changes in magnetic field associated with movement.

Strapdown systems have sensors strapped to the vehicle, which eliminates gimbal lock, removes the need for some calibrations, minimizes the computing hardware requirements, and increases the reliability by eliminating some of the moving parts. Angular rate sensors called “rate gyros” are employed. Whereas gimballed systems could usually do well with update rates of 50 to 60 updates per second, strapdown systems normally update about 2000 times per second in order to keep the maximum angular measurement within a practical range for real rate gyros: about 4 milliradians. Most rate gyros are now laser interferometers. Maintaining precision in the updating algorithms (“direction cosines” or “quaternions”) requires digital electronics, but such computers are now so inexpensive and fast that rate gyro systems are in practical use and mass-produced.

Motion-based alignment infers orientation from position history, as in GPS for cars and aircraft, where the velocity vector usually implies the orientation of the vehicle body. Honeywell's Align in Motion (Doug Weed, et al., “GPS Align in Motion of Civilian Strapdown INS,” Honeywell Commercial Aviation Products) is an FAA-certified process in which the initialization occurs while the aircraft is moving, in the air or on the ground; it uses GPS and an inertial reasonableness test (allowing commercial data integrity requirements to be met) and recovers pure INS performance equivalent to stationary align procedures for civilian flight times up to 18 hours. It avoids the need for gyroscope batteries on aircraft.

Vibrating gyros are used in inexpensive navigation systems as for automobiles, may use a vibrating structure gyroscope to detect changes in heading, and the odometer pickup to measure distance covered along the vehicle's track. This type of system is much less accurate than a higher-end INS, but is adequate for typical automobile applications in which GPS is the primary navigation system, and dead reckoning is needed only to fill gaps in GPS coverage when buildings or terrain block the satellite signals.

Hemispherical Resonator Gyros (HRG or “Brandy Snifter Gyros”) employ a standing wave induced in a hollow globular resonant cavity (i.e. something like a brandy snifter); composed of piezoelectric materials such as quarts; when the cavity is tilted the waves tend to continue oscillating in the original plane of motion, thereby allowing measurement of the angle between the original and turned plane of motion. The electrodes to start and sense the waves are evaporated directly onto the quartz. This system has almost no moving parts, and is very accurate, though at present the cost of the precision ground and polished hollow quartz spheres limits the scope of practical use. The classic system is the Delco 130Y HRG, developed about 1986.

Quartz rate sensors are usually integrated on silicon chips. Each of these sensors has two mass-balanced quartz tuning forks, arranged “handle-to-handle” so forces cancel. Aluminum electrodes evaporated onto the forks and the underlying chip both drive and sense the motion. The system is inexpensive, and the dimensional stability of quarts makes the system accurate. As the forks are twisted about the axis of the handle, the tines' vibration tends to continue in the same plane of motion, which is resisted by electrostatic forces from electrodes under the tines. By measuring the difference in capacitance between the two tines of a fork, the system determines the rate of angular motion. Current non-military versions include small solid state sensors that can measure human body movements; they have no moving parts, and weigh about 50 grams. Solid state devices such as these are used to stabilize images taken with small cameras or camcorders, can be extremely small (5 mm) and are built with MEMS (Microelectromechanical Systems) technologies.

Magnetohydrodynamic (MHD) sensors are used to measure angular velocities; their accuracy improves with the size of the sensor.

Laser gyros eliminate the bearings in gyroscopes, and thus avoid most disadvantages of precision machining and moving parts. A laser gyro splits a beam of laser light into two beams in opposite directions through narrow channels in a closed optical circular path around the perimeter of a triangular block of temperature-stable cervit glass block with reflecting minors placed in each corner. When the gyro rotates at some angular rate, the distance traveled by each beam becomes different—the shorter path being opposite to the rotation. The phase shift between the two beams is measured by an interferometer, and is proportional to the rate of rotation (the Sagnac effect). In practice, at low rotation rates the output frequency can drop to zero (i.e., no interference detected) after the result of “back scattering,” causing the beams to synchronize and lock together, which is known as a “lock-in”, or “laser-lock.” To unlock counter-rotating light beams, laser gyros either have independent light paths for the two directions (usually in fiber optic gyros), or the laser gyro is mounted on a piezo-electric dither motor that rapidly vibrates the ring back and forth about its input axis through the lock-in region to decouple the waves. The shaker design is accurate because both light beams use exactly the same path, but does contain moving parts though they do not move far.

Pendular accelerometers have a mass which can move only in-line with a spring to which it is attached. For an open-loop system, acceleration along the axis of the spring causes a mass to deflect in the other direction, and the offset distance is measured. The acceleration is derived from the values of deflection distance, mass, and spring constant. The system must also be damped to avoid oscillation. A closed-loop accelerometer achieves higher performance by using a feedback loop to cancel the deflection, thus keeping the mass nearly stationary. Whenever the closed-loop mass deflects, the feedback loop causes an electric coil to apply an equally negative force on the mass, canceling the motion and greatly reducing the non-linearities of the spring and damping system. Acceleration is derived from the amount of negative force applied. In addition, this accelerometer provides for increased bandwidth past the natural frequency of the sensing element. Both types of accelerometers have been manufactured as integrated micromachines on silicon chips.

Commercial sources for inertial navigation systems and or their components include the following.
AeroSpy Sense & Avoid Technology GmbH, Austria
Applanix—A Trimble Company, Canada
Crossbow Technology Inc., USA
Dewetron, Austria
Deutsche Montan Technologie GmbH, Germany
Flexit, Sweden—borehole positioning systems.
Honeywell Inc., USA
IGI, Germany
iMAR Navigation GmbH, Germany—European solutions for global industrial and defense applications with all types of inertial sensor technology
InterSense, USA—miniature inertial sensors and hybrid tracking systems.
Invensense—silicon chip sensors
iXSea, France
Kearfott Guidance & Navigation Corporation, USA
Kongsberg Maritime, Norway
Microbotics Inc, USA—GPS-Aided INS
MicroStrain—inclinometers and orientation sensors
Nec-Tokin, Japan—miniature ceramic sensors
Navigation Systems index Northrop Grumman, USA
Litef, Germany (a division of Northrop Grumman, USA)
Northrop Grumman Italia, Italy (a division of Northrop Grumman, USA)
Sperry Marine (a division of Northrop Grumman, USA)
Sagem, France
SEG, Germany
Systron Donner Inertial, USA (owned by Schneider Electric)
TUBITAK—SAGE, Turkey—Integrated Inertial Navigation Systems
Technaid, Spain—Inertial Measurement Systems
TRX Systems, Inc—Integrated Inertial Navigation Systems
U.S. Dynamics Corporation, USA
Verhaert, Belgium
Xsens, Netherlands—miniature solid state sensors

In a particular embodiment of a device according to the invention, the NSBD employs an inertial navigation system, by which it determines path parameters for an asset such as velocities, acceleration, paths taken, distances, and the like.

### Altimeters

The height of an asset's location is of interest particularly where the asset may be located in a building having two or more floors. The indirect measurements common for altitude cause absolute errors that depend on the geographic region and time, but for relative measurements in a space of less than a square mile or two over the course of a few minutes, the precision is more than sufficient.

A pressure altimeter (also known as a barometric altimeter) is the altimeter most commonly used. In it, an aneroid barometer measures the atmospheric pressure from a static port outside the point of reference. Air pressure decreases with an increase of altitude approximately 100 millibars per 800 meters or one inch of mercury per 1000 feet near sea level. The altimeter is calibrated to show the pressure directly as an altitude above mean sea level, based on a mathematical model defined by the International Standard Atmosphere (ISA).

The imprecision arises because atmospheric pressure changes as the weather does. It is not unusual for air pressure to change by 1 mbar due to temperature change alone. This 1 mbar change in pressure could result in a skewed altitude reading of up to 26 feet (8 meters). On a day with very substantial weather changes, as with an approaching cold front, air pressure could change by as much as 5 mbar or more and result in a skewed altitude reading of up to 130 feet (40 meters) or more. Typically as bad weather approaches the ambient air pressure falls, and is interpreted by the altimeter as an increase in altitude. The opposite is true when weather improves. To compensate, an altimeter must be calibrated using a known altitude or a known pressure value, e.g., at a specific landmark or at a specific ride. If the specific altitude is unknown, a known pressure value will suffice. Typically a barometric pressure value is used for calibration, measuring current air pressure at sea level for a specific location. Official barometric pressure reports are updated several times per day, and can usually be obtained from various weather information sources, and can be specific for each asset site.

In certain embodiments of devices according to the invention, the device employs an altimeter. In some embodiments, the device records the altitude change during an assets movement. In additional embodiments, the device records the rate of altitude change. In yet another embodiment, the device records the closest probable altitude for a location in a single cycle of moment. In a further embodiment, the device accepts user inputs to calibrate the altimeter (e.g., “floor no.: 45”). In still further embodiments, the device accepts user inputs noting the difference between measured and actual altitudes.

Altitudes are well known for ground level locations in many cities, but it is not completely necessary to have this information. In one embodiment, where the absolute altitude or floor number is not precisely known for the location of a missing device that has been tracked to a particular multi-story building, search personnel use a second altimeter or other means to determine the altitude for the ground level of the particular building. They then deduce from transmissions where the missing asset is within one or two floors of its location. A combination of GPS, altimeter and optionally RFID can then be used to triangulate the location of the missing asset and recover it. An example of assets that may be tracked by such means include: mis-delivered packages; equipment left behind by construction contractors; electrical paddles needed to resuscitate heart attack victims in the event that comparable equipment fails in nearby buildings; valuable gems stolen from a retail location; smuggled drug contraband; documents taken for industrial or governmental espionage; stolen briefcases; missing persons; and the like.

### RFID Features

RFID (radio frequency identification), also known as dedicated short range communication (DSRC), employs electromagnetic or electrostatic coupling in the radio frequency (RF) portion of the electromagnetic spectrum to acquire or transmit unique identification information, which in the past has generally concerned an object, animal, or person. RFID is a popular commercial alternative to bar codes because it does not require direct contact or line-of-sight scanning. The error rate for RFID scanners is only about 0.5%, significantly less than the scanning errors that arise from line-of-sight reading for bar codes.

An RFID system comprises three components: an antenna and transceiver (often combined within one reader) and a transponder (the tag). RF signals transmitted from the antenna activate the transponder tag, which then transmits data back to the antenna. The data instructs a programmable logic controller to conduct some action which could be a mechanical motion or could be interfacing with a database for a transaction or data release. Low-frequency RFID systems (30 KHz to 500 KHz) have short transmission ranges (usually <6 six feet). High-frequency RFID technology (850 MHz to 950 MHz and 2.4 GHz to 2.5 GHz) has longer ranges (more than 90 feet). Higher frequency systems tend to have higher costs. The signal strength at the source also plays an important role in determining the outer reach of transmission ranges.

In an illustrative embodiment using RFID, NSBDs according to the present invention comprise a receiver for RFID labels. In one embodiment the NSBDs read electronic data from a RFID transmitter posted at the gate of a local work site in order to name files, set default values, and program for work cycle features of special interest. In another embodiment, a signal transmitted via RFID autonomously toggles the NSBDs motion detection mode on at the scheduled daily quitting time for a work site or off at the scheduled daily starting time for a work agenda. In a further embodiment, the default setting for signal transmission via RFID is constantly on, but when low battery charge is detected the signal is autonomously toggled off during scheduled work hours to preserve power, or is toggled to “low power” alarm mode.

In another illustrative embodiment the NSBD is part of a system comprising an asset in close proximity to a first circuit having a transmitter and receiver, and a human carrier in close proximity to a second circuit having a transmitter and receiver. The two circuits are in constant electronic communication with one another by means of RFID signals over short distances. Upon a failure of either circuit to detect the other, the circuit recognizing the failure condition provides a visual and or auditory alarm, and or transmits an alarm and location information signal to a communications device or central server. Optionally the alarm is provided after a default period of 2 to 5 seconds. In one embodiment the RFID signal strength and receiver sensitivity are tuned to have an outside effective range of 3 feet; in another embodiment it is 6 feet, in a further embodiment it is 10 feet; in still another embodiment it is 30 feet; in yet another embodiment it is 90 feet; in a further embodiment it is 300 feet; in a particular embodiment the range is tunable; in a further embodiment the system hardware and or programming are designed or tuned so that one of the detection circuits will detect a failure event sooner than the other. When the RFID is placed as a security precaution it may optionally be attached to the asset in a manner that is difficult to remove or disable, and or may be attached at a location of the asset that is inaccessible or hidden from view. In a particular embodiment a RFID component and a GPS component are affixed to an asset at a fixed distance from each other and are in constant electronic communication with one another; if this fixed distance changes then the NSBD transmits an emergency signal to a client and a central server reporting a “potentially tampered” status.

### Transmitting and Reporting

The NSBD may not only receive but also transmit by any medium and frequency that is practicable for wireless communication, including by telephony, short wave radio, digital or analog signal, marine band, or other remote telecommunication medium. For transmitting to a central server a telephonic or paging signal is particularly useful. Communications between a client and central server may conveniently employ any practicable medium, wireless or otherwise. This may include telephone calls, wireless text messages, email, postings to a website, and other media.

In one embodiment of transmission and reporting, when the NSBD comes within 32 foot range of a Bluetooth™ device there is “connection made” allowing automatic notification of the client. In this embodiment, when the NSBD is “ACTIVE/ON” in that range of distance, the user will be able to detect its presence via software applications run to “watch” for the appropriately “named Bluetooth™ device”. The NSBD will then contact the central server and or the client through the Bluetooth™ device.

Bluetooth™ is a wireless communication protocol that uses short range radiofrequency transmissions to connect and synchronous fixed and or mobile electronic devices into wireless personal area networks (PANs), yet with low power consumption. Its specification is based on frequency-hopping spread spectrum technology. The Bluetooth™ specifications are developed and licensed by the Bluetooth™ Special Interest Group (SIG), and involve transceiver microchips in each of the communicating devices. The Bluetooth™ SIG consists of companies in the areas of telecommunication, computing, networking, and consumer electronics. Most Bluetooth™ devices have unique addresses, unique names, can be configured to advertise their presence. Connectable devices for Bluetooth™ include mobile and other telephones, laptops, personal computers, printers, GPS receivers, digital cameras, Blackberry™ devices and video game consoles over a secure, globally unlicensed Industrial, Scientific and Medical (ISM) 2.4 GHz short-range radiofrequency bandwidth. Bluetooth™ is supported on Microsoft™, Mac™ Linux and other operating systems.

Under current Bluetooth™ technology Class III (1 mW (0 dBm) devices have a range of 3.2 feet (or 1 meter); Class II 2.5 mW (4 dBm) devices (i.e. most bluetooth cell phones, headsets and computer peripherals) have a range of 32 feet (or 10 meters); and Class I (100 mW, 20 dBm) devices have a range up to 100 meters. In most cases the effective range of class 2 devices is extended if they connect to a class 1 transceiver, compared to pure class 2 network. This is due to the higher sensitivity and transmission power of Class 1 devices. The transmissions can be farther; Class 2 Bluetooth radios have been extended to 1.78 km (1.08 mile) with directional antennas and signal amplifiers. Transmissions also do not need to be within the line of sight, and if the signal is strong enough can penetrate a wall.

Current data transmission rates are in the range of 1 Mbit/s (version 1.2) or 3 Mbit/s (Version 2.0+EDR), but under improvements proposed by the WiMedia Alliance would increase to 53 to 480 Mbit/s. Currently Wi-Fi technology provides higher throughput and covers greater distances, but requires more expensive hardware and higher power consumption, however unlike Wi-Fi, which is an Ethernet, the Bluetooth™ devices are like a wireless FireWire and can replace more than local area networks and even surpass the universality of USB devices. Bluetooth™ also does not require network addresses or secure permissions, unlike many other networks. Despite discussion in recent years of the possibility of viruses and worms through Bluetooth™, at this time no major worm or virus has yet materialized, possibly because 10,000 companies in the telecommunications, computing, automotive, music, apparel, industrial automation, and network industries and other companies in the SIG are using and improving the devices and sharing their work on the security measures with each other.

### Programming

Illustrative user inputs for the NSBD include the following: Reset for new monitoring cycle; Single cycle history; Accumulated cycle histories; Reset accumulated data to zero; Time—real, Cycle time most recently; and Cycle times cumulative. In one embodiment, prior to each cycle the NSBD is set to “START” by the user, central server, or for a suitable inventory system, by a locally placed RFID device. This allows the device to gauge its starting position; and to use those coordinates as a reference point for the remainder of its measurements in the cycle. The device may recognize the specific characteristics of the cycle by the code of the RFID or by receiving a signal from the server, client, or client's agent. Alternatively the NSBD may be pre-programmed with statistics from each cycle for a repetitive routine.

### Critical Velocity Thresholds for Switching ON or OFF

The velocity algorithm will typically be selected to distinguish between asset speeds, for those of land travel versus speeds for watercraft, aircraft, and hand-held devices. There are a variety of convenient values from which to choose. Speeds for ground transport vehicles seldom exceed 80 or 90 mph even on highways, and speeds on watercraft and conveyor belts are much lower. Thus for toggling, a value between 5 and 90 mph might be selected for the threshold speed. In some embodiments a value of 1 mph is selected as the threshold speed (a very slow walk). In further embodiments the threshold value is optionally any multiple of 5 mph up to and including one thousand (1,000) mph. Thresholds in excess of 100 mph may be desired, for instance, for race cars, planes, and rockets. In additional examples, toggling occurs when the velocity is zero following a specific time period of non-zero velocity. This condition models the timing for slowing activity, coming to a stop, and leaving the vehicle. A particular embodiment for this case is tracking packages or other items placed on aircraft.

In a particular embodiment, the thresholds for velocity and g-force are programmable for each NSBD. They may be pre-programmed for certain conditions (i.e. airline travel); and they can optionally be re-set by the client or by a signal received by the NSBD from a central server.

### Central Server

The ability to assign a unique identifying code to each NSBD—and thus to the asset being tracked—allows for a particular central server to monitor and respond to movement patterns simultaneously for dozens, thousands, or even millions of assets. Such a server can monitor assets that would normally be considered unlike each other, thus avoiding the need for specialized tracking software for each type of item. Thus whether the asset is a motorcycle, a purse, an electronic device, a shipped package, or a human such as a sales clerk or meter reader, the programmed tracking parameters and unique code for each asset can enable a single server to track them all economically without distinction. In other illustrative embodiments the central server may be operated in a manner that is dedicated to tracking particular types of property, such as a home alarm monitoring company, security company for retail jewelry, insurer of valuable art, cargo transport firm, express package shipping service, armored car service, or detective unit conducting surveillance of smuggling.

In some embodiments, the tracking of human assets employs a dedicated central server. Non-exclusive illustrative embodiments for tracking human assets through a dedicated central server include an eldercare health monitoring company, such as for tracking the location of Alzheimer's disease patients who in their senility may wander away from their residence or assisted living facility; such a server may also, for instance, remotely recognize g forces tantamount to the slip-&-fall level for elderly individuals in independent living. Central servers may likewise be dedicated to hazardous professional situations, for which illustrative embodiments include: a military unit that tracks signals from dog tags equipped with GPS circuits to find and recover its casualties from a battlefield; a news reporting organization that tracks signals from silent alarm watches worn by personnel in areas known to be frequented by guerrillas or terrorists; and a firefighting unit that monitors signals from helmets to track and guide emergency personnel in incendiary situations characterized by low visibility. And of course, central servers may monitor activity in the furtherance of an employer's purposes. Illustrative examples include for tracking the whereabouts or well being of: garbage crews; mail delivery personnel; meter readers; traveling sales personnel; truck drivers; census takers; news reporters; on-call emergency personnel; and the like.

A central server may be operated by a private individual, or may be maintained by a corporate in-house function, or may be under the aegis of a public agency, or may be provided as a third-party service or by other outsourcing, or may be operated by any other means that the user, client, or service deems appropriate.

The following illustrative embodiments exemplify various embodiments of the invention as described, but the invention is not so limited.

### Example 1

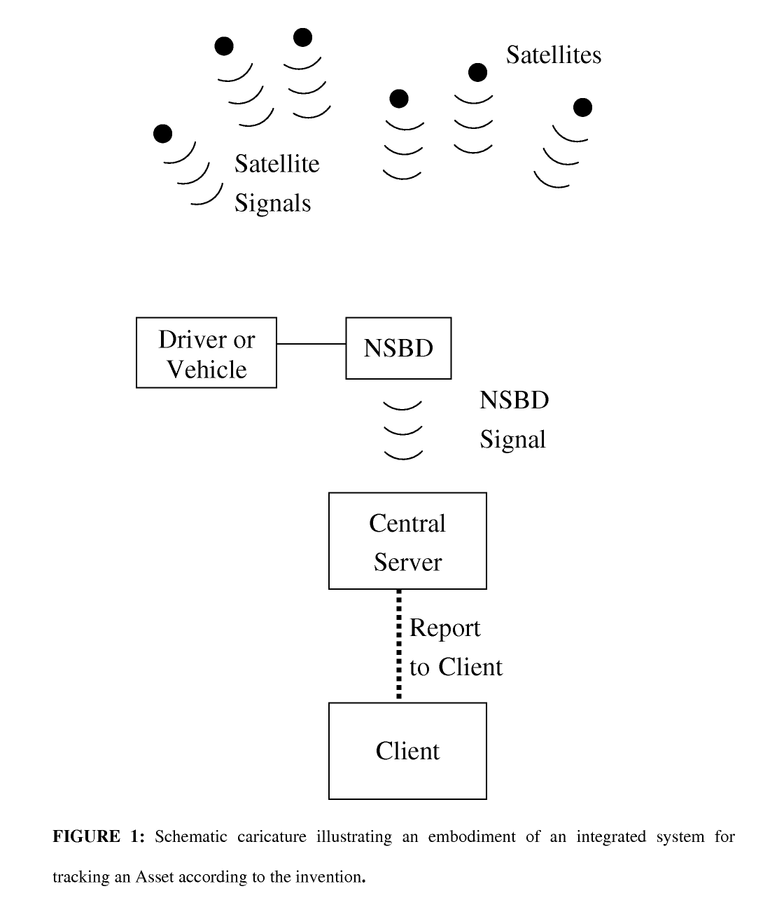

As shown in FIG. 1, a constellation of navigational satellites broadcast positional information on a steady basis. A NSBD that is located near (i.e., physically associated with) an asset, receives those signals and then broadcasts a signal of its own, which is routed to a central server, and subsequently position information about the NSBD is reported to a client.

### Example 2

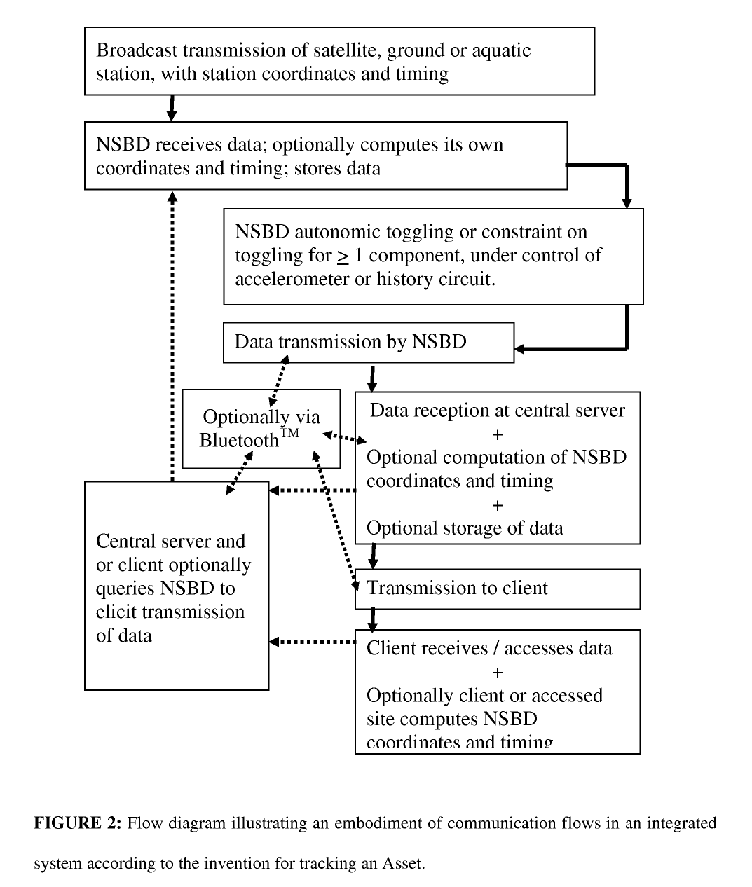

As shown in FIG. 2, broadcast information from navigational stations in space, on land or on water are received, from which—if it is so configured or programmed—the NSBD may optionally compute its own coordinates and timing. A component of the NSBD such as but not limited to the transmitter is governed by autonomic toggling. The autonomic effect is achieved directly by a circuit that closes or opens when an accelerometer detects a critical threshold of g-force, or when a time-based algorithm in combination with an accelerometer detects a critical threshold of velocity, or when a specified geographic area is entered. Alternatively the autonomic effect is achieved by a history circuit that closes (or opens) only after a start is detected, thereby removing constraint against the off mode for a switch. When the switch is on, the NSBD transmitter sends a signal, but to conserve a power source it may be an intermittent or on-demand signal. One reason for shutting down most or all components of the NSBD during trip conditions that are not of interest is to prevent battery drain. During travel it is often inconvenient to recharge batteries, and generally impossible to recharge personal electronic devices remotely except where they are wired into the asset's power source. Thus the NSBD might be set to activate only in response to conditions such as hyper-acceleration, swerving, and or sharp slowing, or to report only such conditions. The NSBD might also be set to activate when the internal power is sufficiently low (i.e. 10% of full power level) to indicate the Asset's final position prior to battery drain and failure. Because different battery chemistries differ in their end-of-cycle power profiles, and other types of energy sources also differ, the NSBD may also be programmed with information about the type of battery or other energy device that currently resides in its power supply.

In a particular embodiment the central server shown in FIG. 2 is operated by a vendor company that tracks assets. There the server optionally also calculates time and position. In a further embodiment the server acts as a router or switchboard for sorting and relaying emails or wireless telephone calls. In a particular embodiment information from the NSBD is downloaded or otherwise retrieved by a system manager daily as needed without other transmission. In another embodiment the information is transmitted to a central server on a fixed schedule. In other embodiments the information is transmitted in response to queries. Limiting transmissions to responses to specific queries is another way to limit battery drain in NSBDs.

Optionally, when the NSBD device is “ACTIVE/ON” and within 32 feet of the user/owner of a Bluetooth™ device; the NSBD user will be able to detect its presence via software applications run to “watch” for the appropriately “named Bluetooth™ device”, and will then be able to communicate with either the server or the NSBD to establish its location. Alternatively, the client or central server may do so, for instance by means of a cell phone or laptop device in which a microchip provides Bluetooth™ functionality.

### Example 3

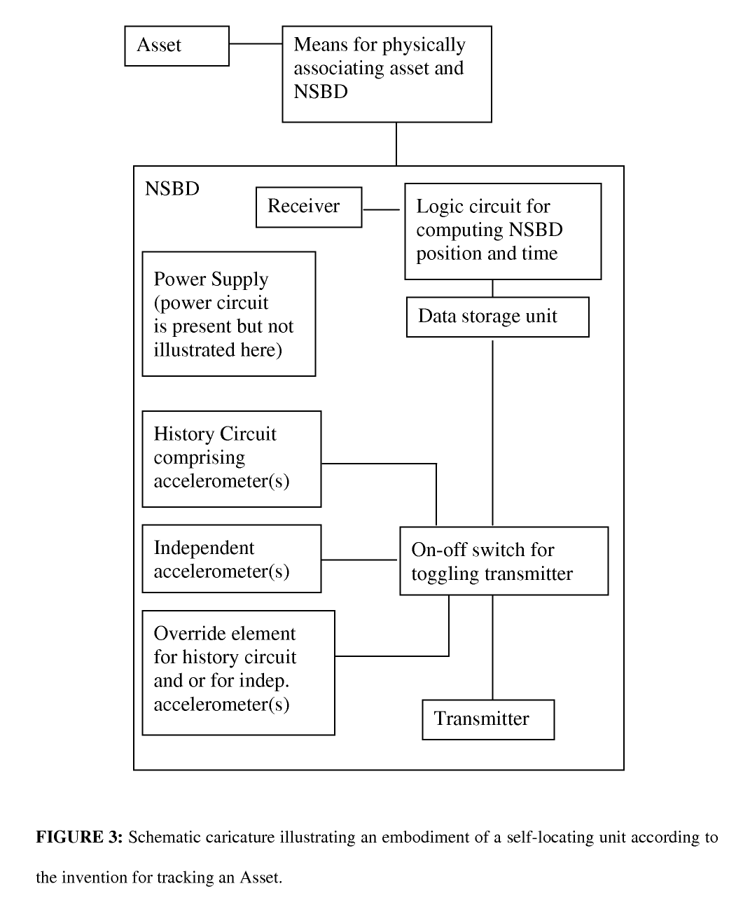

FIG. 3 illustrates various components of the NSBD. Here a power supply is shown, but the features the actual circuit for the power is not shown. The receiver is in electrical connection with a logic circuit—in this embodiment the NSBD is configured to compute its own position information and not merely to aggregate information received from satellites or other navigation stations. The data is sent into a memory and then optionally retrieved for transmission. The ability to transmit, however, is governed in this example by independent accelerometer(s) that can toggle a power-down of the transmitter when needed and toggle its power-up. A history circuit augments the independent accelerometers.

When the device settings control transmission ability through the history circuit, the client can turn on the NSBD, and it cannot be turned off again autonomously or by a wireless electronic query from a remote source until the history circuit detects an end-of-cycle event (e.g., arrival at destination, or particular clock time, or threshold period of disuse). This feature allows a NSBD's receiving, computational and history tracking functions to be active even though the NSBD's transmission capability is not toggled on until detection of a “forbidden” event such as speeding, swerving or weaving. An alternative way to accomplish the same result is for a client to use a remote control such as an encoded signal from a cell phone to power on the NSBD's receiving, computational and or history storage functions remotely before or during the use cycle, allowing a later query or the independent accelerometer to serve as the on-toggle for transmission when reporting conditions are recognized. The combination of an accelerometer and a chronometer for deceleration will ensure that mere bumpiness of the path does not reactivate the transmitter.

FIG. 3 also illustrates the presence of an optional override element. In the event that a NSBD transmitter is in the off mode because of constraints by a history circuit—which could arise from an erroneous detection of a start, or from a failure to recognize a full stop at the destination—no transmission can occur. This will affect the NSBD's ability to self-report the location of the associated user or vehicle when either is missing. The override element shown here illustrates a means for decoupling the NSBD's accelerometer and or history circuit in such cases to enable transmission.

### Example 4

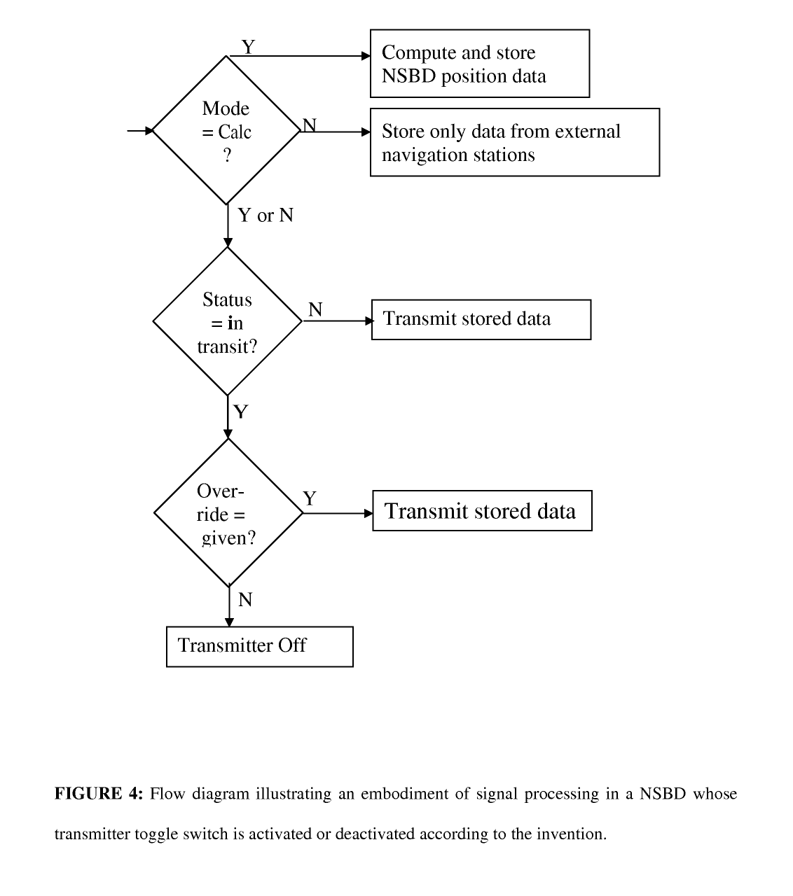

As shown in FIG. 4 the signal for transmission can be processed in a relatively straightforward way. In a particular embodiment, data from external navigation guidance stations is received, can optionally be stored “as is”, and can be used—if the NSBD is so configured and programmed—to generate a fix on the NSBD's position autonomously. The stored data is not released for transmission unless the circuit finds “go” status. Where the circuit does find in-transit designation, the transmitter is kept in the “off” mode unless a reporting event is detected or an override code has been entered (e.g., remotely). For the override case the transmitter will then be restored to its “on” mode.

### Example 5

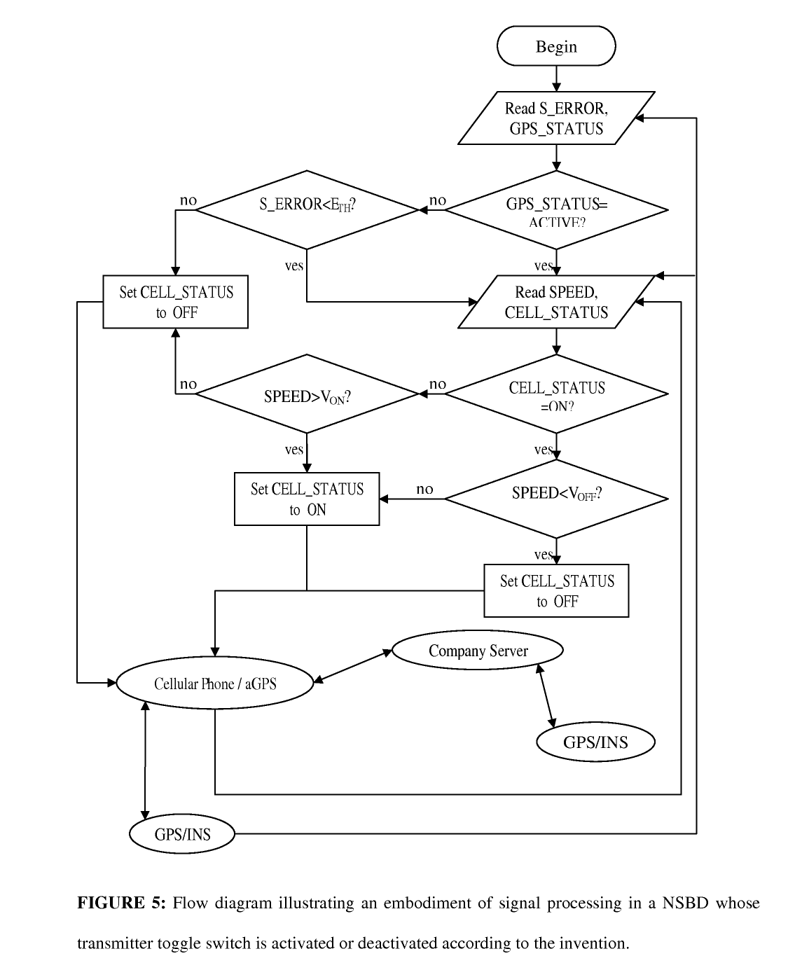

Referring now to FIG. 5, the signal for transmission may optionally be processed from a plurality of navigation data sources in a relatively straightforward way. In a particular illustrative embodiment, the high-level requirements of the device are as follows:
1. Determine geographic location
2. Communicate geographic location to user
3. Ensure that transmission capability is enabled when the asset is in transit or above threshold values.

In this embodiment the transmission is accomplished by coupling assisted GPS (aGPS), cellular telephone technology, and INS or other accelerometer-based circuit with a switching device that toggles transmission capability “on” when a potential “in-flight” condition is detected.

In this example the NSBD has at least the following four input signals from the aGPS(/INS) module and cellular communication device.
SPEED—the magnitude of the velocity vector determined by the navigation system.
GPS_STATUS—an indicator variable representing whether GPS is capable of determining position without cellular assistance.
S_ERROR—an estimate of the margin of error in measurement of the velocity.
CELL_STATUS—an indicator variable denoting whether transmission capability is on or off.

In this particular example two conditions are specified, as follows.
V_{ON}—represents the “in-transit” condition in which the computed speed of the device exceeds a pre-defined threshold.
V_{OFF}—represents the “standstill” or slow condition in which the computed speed of the device is below a pre-defined threshold.
   The “in-transit” status is retained until a reliable speed measurement is obtained below the pre-defined threshold, V_{OFF}. The reliability of the speed measurement is determined by evaluating the GPS_STATUS and S_ERROR parameters defined above.

Data from a navigation guidance source is received and evaluated for the margin of error (“S_ERROR”) in the computed velocity is determined. If upon a query the NSBD unit is found to be capable of determining position based on the accessible GPS data alone without assisted GPS (“GPS_STATUS”), the magnitude of the velocity (“SPEED”) is determined from the navigational data.

If GPS_STATUS=ACTIVE, the NSBD will proceed with a calculation of navigation data. By contrast, if the status is not active, the algorithm evaluates whether the computed margin for error in the velocity is below a pre-defined threshold level (S_ERROR<E_{TH}). If the computed level of error exceeds the threshold level, the device does not query—or alternatively sets itself not to receive—navigational information from a cellular telephonic source (“Set CELL_STATUS to OFF”). If the calculated margin for error does not exceed the threshold level, the NSBD will obtain speed information from inertial navigation

For active-mode GPS in this example, the logic circuit computes the velocity vector determined through the navigation system. It also determines whether cellular telephonic capability (“CELL_STATUS”) is on or off. If CELL_STATUS is on, the algorithm determines whether the unit is in in-transit condition, i.e., whether the speed exceeds a pre-defined threshold (“V_{ON}”). If CELL_STATUS is off, the algorithm determines whether the speed falls below another pre-defined threshold (“V_{OFF}”). In-transit status is maintained until the speed falls below V_{OFF}, where the subscripts ON and OFF refer to conditions for transmitting position from the NSBD.

CELL_STATUS is set to OFF once the measured SPEED falls below V_{OFF} and remains OFF until SPEED exceeds V_{ON} and or SPEED measurements are deemed unreliable (S_ERROR>E_{TH}). CELL_STATUS is set to ON if the computed SPEED is greater than or equal to V_{ON} or the computed S_ERROR is greater than or equal to E_{TH}. The CELL_STATUS mode is communicated to or available upon query to a cellular phone and or assisted GPS (“aGPS”) system which is in communication with a server and a GPS/INS system. The GPS/INS system, when present, provides data refinements and corrections, which are then communicated electronically to at least one of the server, the cellular phone/aGPS system, and or the NSBD directly. When the GPS/INS system communicates directly to the NSBD, in this example it does so at the step of assessing the error in speed and the status of the GPS capability.

### Example 6

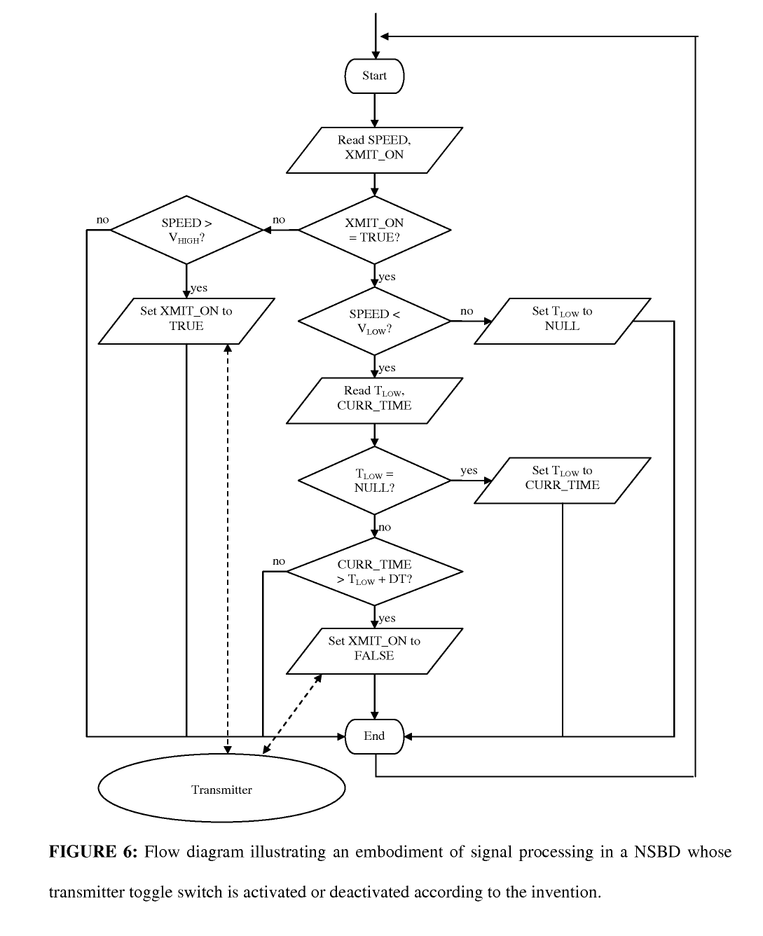

Referring now to FIG. 6, the signal for transmission may be toggled on or off in a relatively straightforward way under the control of parameters derived from navigation data sources.

As an example, first the asset's speed is ascertained, for instance from the acceleration and time variables in the NSBD history file and or from the NSBD positional data as a function of change over time. The NSBD's transmission activation status is also ascertained. One of four control scenarios follows.
1. If the NSBD is not in the ON mode for transmission (i.e., XMIT_ON does not equal TRUE), and the Asset's detected velocity (SPEED) does not exceed the threshold condition for transmitting. (>V_{HIGH}), then that iteration of the logic loop is concluded. The transmitter remains off.
2. If the NSBD is not in the ON mode for transmission, but the Asset's detected SPEED exceeds the threshold condition for transmitting (>V_{HIGH}), toggled on (“Set XMIT_ON to TRUE”), and that iteration of the logic loop is concluded. The transmitter is now on.
3. If the NSBD is in the ON mode for transmission (XMIT_ON=TRUE), and the Asset's detected SPEED does not fall below the threshold condition for transmitting. (i.e., it is not less than V_{LOW}), then the timing for the slow or standstill condition is re-zeroed (“Set T_{LOW} to NULL”), and that iteration of the logic loop is concluded. The transmitter remains on.
4. If the NSBD is in the ON mode for transmission and the Asset's detected SPEED falls below the threshold condition for transmitting. (<V_{LOW}), the NSBD continues to measure the amount of time elapsed below that speed threshold (T_{LOW}), where each length of lapsed time (CURR_TIME) is reviewed until the threshold quantum of time since the onset (NULL value for T_{LOW}) is surpassed (i.e., CURR_TIME>T_{LOW}+DT). At that point the transmitter is toggled off (“Set XMIT_ON to FALSE”) and that iteration of the logic loop is concluded. The transmitter is now off.

### Example 7

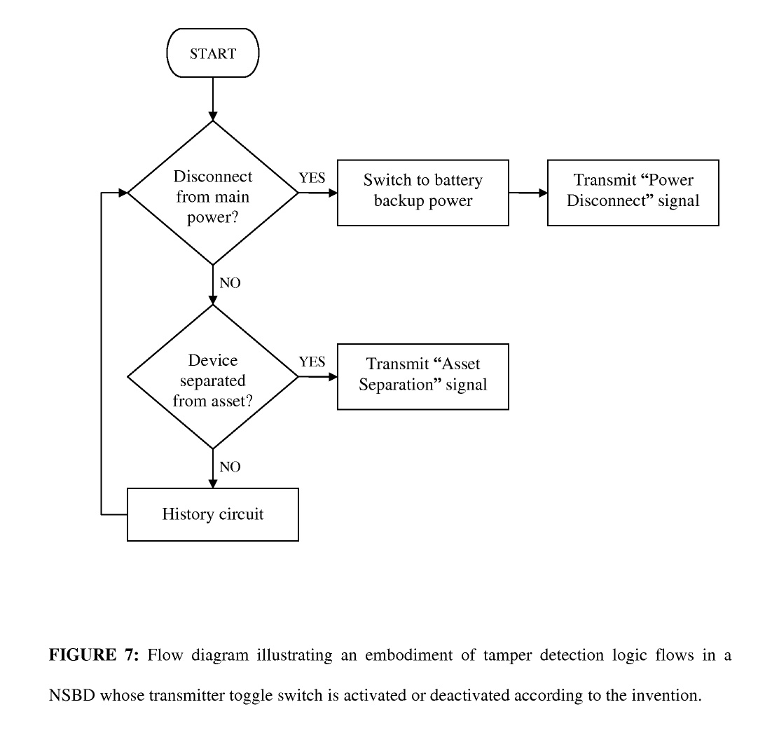

Referring now to FIG. 7, in a particular embodiment tamper detection logic may toggle asset status and alternative power sources on or off in a relatively straightforward way under the control of parameters derived from asset data sources.

In a particular embodiment, after detecting a power disconnect and or migration of an asset, a device according to the invention transmits a “potentially tampered” status. The detection capabilities may be part of or in line with the history circuit. Upon disconnection of the main power, or upon detection of a sufficiently low-power state of the primary power source, the device switches from a primary power source to a secondary source such as a back-up power supply, and transmits one or more messages communicating a power disconnected state. Similarly, upon detecting separation of the device from the asset, the device transmits one or more messages communicating a power disconnected state. The separated state can be detected through one or a combination of methods including but not limited to, the following illustrative embodiments.
Distance-measuring RFID with a tag applied to the asset, and a reader incorporated into the NSBD.
Standard RFID tag applied to the asset, with reader incorporated into the NSBD, with distance separation threshold determined by effective range of RFID system.
Magnetic tag applied to the asset, with reader incorporated into the NSBD.
Radio beacon attached to the asset, with receiver incorporated into the NSBD, with distance separation threshold determined by the effective range of the beacon.
Separate insert piece attached to the asset for physical attachment to the NSBD, with connection indicated by physical switch movement, electrical connection, or other means.

In the event that a “potentially tampered” status is detected, an “alert” status is reported or transmitted at one or more components of the NSBD. The alert may optionally be registered or communicated at a visual display, RFID component, GPS component, transmitter component, central server, or some combination of these.

### Example 8

In a further illustrative example, the asset is a driver or vehicle, the NSBD monitors the path or its detection and transmission are triggered by g-forces for erratic motion. In these particular embodiments the NSBD automatically reports conditions that it is pre-programmed to recognize.

In a particular embodiment the NSBD remotely alerts a parent to dangerous driving patterns by a teenager based on patterns of rapid acceleration, sudden slowing, cornering, swerving, vertical jarring (as in off-road use), and the like. In another embodiment the NSBD remotely alerts a police dispatcher or concerned family member to erratic driving by a person who is currently under legal restrictions due to a previous conviction for driving under the influence of an intoxicating substance. In an alternative embodiment the NSBD remotely alerts a guardian or concerned family member to erratic driving patterns by an ill, elderly, mentally impaired, or physically disabled person. Examples of relevant impairments include but are not limited to diabetic mental lapses, epilepsy that has been controlled by medical treatment for a sustained period, psychiatric impairments, and the like.

In a further embodiment the NSBD notifies aviation authorities or military personnel of pre-defined reckless flight characteristics or of distressed performance of a vessel flying under difficult weather conditions. In another embodiment the NSBD notifies coastal authorities or military personnel of pre-defined reckless boating characteristics or of distressed performance of an aquatic vessel under difficult boating conditions. In yet another embodiment the NSBD automatically remotely notifies superiors or support troops when a combat vehicle encounters a dangerous condition, such as being overturned or registering shell shocks.

In yet another embodiment the asset is a rental vehicle, and the NSBD reports excessive speeds, cornering, swerving, jarring, and unnecessary g-forces to the owner for the purpose of allocating and limiting insurance liability. In an additional embodiment the asset is an insured vehicle, and the NSBD reports excessive speeds and unnecessary g-forces to the insurer for the purpose of allocating and limiting insurance liability, and for the purpose of setting rates.

In still other embodiment the asset is a construction vehicle, and the NSBD reports one or more characteristics such as use time, dangerous tilt angles, whether the vehicle stayed within defined boundaries, use that may cause excessive wear on the vehicle, or another parameter of interest. In a particular embodiment the NSBD detection circuit is activated at start-up or by perceived motion of the vehicle, and inactivated by a default period of motionlessness.

### Example 9

In further illustrative embodiments, the asset is portable, and the NSBD monitors the path, or its detection and transmission are triggered by the asset's distance from the user or by another event. Programmed distances are as short as 3 feet or as long as 300 feet in the particular embodiments illustrated here

In some embodiments, the NSBD alerts users or clients to potential theft events. In a particular embodiment the NSBD sounds an alarm when a purse is more than six feet from the user. In another embodiment the NSBD sounds an alarm when a briefcase is more than about 10 feet from the user. In a further embodiment the NSBD sounds an alarm when the g-forces necessary to open a latch for a shipping container or luggage item are applied without an override command to the NSBD. In yet another embodiment the NSBD transmits a signal when a laptop computer is more than about 30 feet from its user. The latter embodiment may be used, for instance, by a company remotely monitoring its telecommuting employees, or to indicate a possible theft in progress at an airport. In yet another embodiment the NSBD transmits a signal or sounds an alarm when a printer, scanner, laptop, personal computer, facsimile machine, or other small electronic device is more than about 10 feet from its assigned desk at a worksite or educational facility. In a further embodiment the asset is a server, mainframe computer, affixed electronic camera, manufacturing machine, safe, small vault for valuables, safe deposit box, cargo trailer, or other large but removable asset, and the NSBD is programmed to transmit a signal or sound an alarm when the item is moved more than 10 feet from a chassis without an override command. In yet another embodiment the asset is a financial asset such as currency, received checks, or an investment instrument, and the NSBD is programmed to transmit a signal or sound an alarm when the item is moved more than 6 feet from its authorized location without an override command. In additional embodiments, the NSBD transmits a signal to indicate the path of movement for any of the foregoing assets in this paragraph.

In other embodiments the NSBD alerts users or clients to critical conditions. In a particular embodiment, the NSBD for a laptop or cell phone transmits a signal or sounds an alarm when g-forces equivalent to dropping the device from a height of 3 feet are detected. In another embodiment the NSBD alerts an airline, shipping company or client when an item to which the NSBD has been affixed is subjected to excessive roughness in handling.

### Example 10

In further illustrative embodiments, a vendor receives, optionally monitors, and forwards information from an NSBD to a client or user.

In some embodiments the vendor collects the information on site from the NSBD as by downloading, with no need for other transmission. In other embodiments the vendor remotely receives and stores the information. In particular embodiments the vendor queries the NSBD for transmissions. In some embodiments the vendor receives transmissions on a periodic or scheduled basis from a NSBD. In further embodiments the vendor receives transmissions continually from a NSBD. In some embodiments a break in continuous transmissions from an NSBD triggers an alarm to the vendor, client or user, or triggers replacement or recharging of an energy storage device at the NSBD power supply.

In particular embodiments the vendor compiles and maintains a use history derived from the NSBD data, wherein the data may be as received or processed in some manner. In further embodiments the vendor conducts data mining on the information received from NSBDs, for the purpose of assisting users, clients, or third parties in their assessments of asset use. In particular embodiments the vendor supplies to a third party NSBD data from which user identity information has been stripped out.

In additional embodiments the vendor routes a NSBD signal directly to a designated user's or client's electronic device. In some embodiments the vendor transfers NSBD data to a web site accessible to clients. In further embodiment the vendor summarizes NSBD data in reports to clients. In various embodiments the vendor notifies a user or client of NSBD data only in the event of pre-defined circumstances of interest. In some embodiments vendor routing of NSBD data is on a metered basis for billing.

In some embodiments a vendor's client is a user. In additional embodiments a vendor's client is an employer. In particular embodiments a vendor's client is a parent, guardian, or healthcare provider. In alternative embodiments a vendor's client is a rental agency. In still other embodiments a vendor's client is a party in a construction contract; the party may be the owner of assets monitored by a NSBD or may be the counterparty in a contract for which the assets will be used. In further embodiments a vendor's client is a governmental entity. In some embodiments a vendor's client is a security provider. In alternative embodiments a vendor's client is an insurer.

### Example 11

In a particular embodiment, the asset is a dispatched package or a transported shipping container, and the NSBD monitors the path by means of a GPS component. In a particular embodiment, the g-forces of opening the package or removing the contents trigger a signal that reports the location and optionally the path history of the shipped items. In a further embodiment the shipped contents are sent by a retailer to a customer who has had no history of relationship with the retailer. In the event that the customer fraudulently procures the asset or fraudulently claims a refund for non-receipt or damages to the asset, the report from the NSBD is used to confirm receipt and recover the asset.

In a further embodiment a first RFID device is hidden in intimate association with the packaging or container, and a second RFID device is a component of the NSBD, which is affixed to the package or container contents, such that if the contents are removed to a critical distance from the packaging materials or container before the NSBD is deactivated, a silent signal is automatically transmitted by the NSBD notifying a user, client and or central server of their unpackaged status and reporting the location of the contents and last location where they were associated with the packaging.

In still other embodiments, upon receiving a query signal from a user, client or central server, the NSBD transmits the location and optionally the path history. The NSBD further comprises an altimeter component and optionally tracks the vertical motion history of the package or container such that the relative height of its location in a multi-story building may be determined in the event that the package is mis-delivered.

Having described and illustrated specific exemplary embodiments of the invention, it is to be understood that the invention is not limited to those precise embodiments. Various adaptations, modifications, and permutations will occur to persons of ordinary skill in the art without departing from the scope or the spirit of the invention as defined in the appended claims, and are contemplated within the invention.

What is claimed is:

1) A method for tracking the location of an asset, comprising:
a) placing a navigational system beacon device (NSBD) in close proximity to the asset;
b) receiving at a component of the NSBD a transmission of position information;
c) storing the information or a processed form of it at a component of the NSBD; and
d) transmitting a signal from the NSBD to report the information;
wherein the NSBD's ability to transmit information is toggled on under the control of an accelerometer when the asset attains a pre-defined threshold of velocity or g-force, and or the NSBD's ability to transmit information is toggled off after detection of sustained below-threshold activity, or wherein the toggling on or off of the NSBD's transmission capacity is constrained by a history circuit comprising an accelerometer.

2) The method of claim 1 wherein the signal reporting information from the NSBD is received by or relayed to a central server which then reports the information about the asset to a client.

3) The method of claim 2 wherein the central server or a device held by the client comprises a means for calculating the location of the asset as a function of an information type selected from the group consisting of the relative location of satellites, the relative location of an RFID device, and altitude.

4) The method of claim 2 wherein the central server reports the location of the asset to a client by means of email or by posting the information to a web site that is accessible to the client.

5) The method of claim 1 wherein the NSBD's close proximity to the asset is in a manner selected from the group consisting of: as an item within but not affixed to the asset; affixed to the inside of the asset; affixed to the outside of the asset; as an integral component of the asset; affixed to a dolly for the asset, and as an integral component of the asset.

6) The method of claim 1 wherein at least one of the stored information and transmitted information comprises the relative location of satellites from which the NSBD has received transmitted position information, and or comprises a calculated location of the asset as a function of the relative location of the satellites.

7) The method of claim 1 wherein, in the event that potentially unauthorized removal of the asset is detected, the NSBD's ability to transmit information is autonomously toggled on if it is not already on, and an alarm or other signal is transmitted by the NSBD.

8) The method of claim 1 wherein the NSBD further comprises a means for calculating the location of the asset as a function of the relative location of satellites.

9) The method of claim 1 wherein, when the ability to transmit information from the NSBD is on, the transmission is periodic and or is generated in response to a transmission from the central server or a client.

10) A method for tracking the location of an asset, comprising:
a) receiving a transmission of position information from a satellite or ground station at a component of a navigational system beacon device (NSBD) that is in close proximity to the asset;
b) storing the information or a processed form of it at a component of the NSBD;
c) optionally calculating the position of the asset based on the information received from the satellite or ground station, wherein the calculation is performed at a component of the NSBD;
d) transmitting a signal from the NSBD to a central server to report position information, but wherein
i) the NSBD's ability to transmit information is toggled on under the control of an accelerometer when the asset attains a pre-defined threshold of velocity or g-force,
ii) the NSBD's ability to transmit information is toggled off after detection of sustained below-threshold activity, and or
iii) the toggling on or off of the NSBD's transmission capacity is constrained by a history circuit comprising an accelerometer;
e) calculating the position of the asset at a component of the central server based on the position information received by the NSBD from the satellite or ground station, if the position of the asset had not been calculated at a component of the NSBD; and
f) transmitting position information from the central server electronically to a client telephone, email address, handheld navigational device or client-accessible web page entry;
wherein position information received at the NSBD is processed to determine the location or optionally velocity or acceleration of the asset, and wherein the determination is by means of a computation at the NSBD, the central server, the handheld navigational device, the client-accessible web page, or a combination thereof.

11) The method of claim 10 wherein the accelerometer is a mobile unit associated with the NSBD and the asset.

12) The method of claim 10 wherein the accelerometer is associated with the operating equipment of a vehicle.

13) A self-locating unit comprising an asset in close proximity to a navigational system beacon device (NSBD), wherein the NSBD comprises:
a) a component that can receive transmissions of position information;
b) a component that can store position information;
c) a component that can transmit position information; and
d) one or more accelerometers under the control of which the NSBD's ability to transmit information is toggled on when the asset attains a pre-defined threshold of velocity or g-force, and or the NSBD's ability to transmit position information is toggled off after detection of sustained below-threshold activity, or wherein the toggling on or off of the NSBD's transmission capacity is constrained by a history circuit comprising an accelerometer.

14) The self-locating unit of claim 13, wherein the NSBD's close proximity to the asset is in a manner selected from the group consisting of: as an item within but not affixed to asset; affixed to the inside of the asset; affixed to the outside of the asset; as an integral component of the asset; affixed to a dolly for moving the asset; and as an integral component of a dolly for moving the asset.

15) The self-locating unit of claim 13, wherein the NSBD further comprises a means for calculating the location of the asset as a function of the relative location of satellite positions.

16) The self-locating unit of claim 13, wherein when the transmission ability is on, its transmission can be periodic and or generated in response to a transmission from a central server or a client.

17) The self-locating unit of claim 13, wherein the position information that can be stored comprises the relative location of satellites from which the NSBD has received transmissions of position information, and or comprises a calculated location of the asset as a function of the relative location of the satellites.

18) An integrated system for tracking the location of an asset, comprising:
a) an asset;
b) a navigational system beacon device (NSBD) in close proximity to the asset, wherein the NSBD comprises:
i) a component that can receive transmissions of position information;
ii) a component that can store position information;
iii) a component that can transmit position information; and
iv) one or more accelerometers under the control of which the NSBD's ability to transmit information is toggled on when the asset attains a pre-defined threshold of velocity or g-force, and or the NSBD's ability to transmit position information is toggled off after detection of sustained below-threshold activity, or wherein the toggling on or off of the NSBD's transmission capacity is constrained by a history circuit comprising an accelerometer;
c) a central server that can receive position information from the NSBD's transmissions and communicate position information to a client; and
d) a means for sending position information electronically to the client from the central server, and or a web site accessible to the client wherein the web site is capable of receiving and displaying position information.

19) The integrated system of claim 18, wherein at least one of the NSBD or central server further comprises a means for calculating the location of the asset as a function of the relative location of satellite positions.

20) The integrated system of claim 18, wherein the NSBD further comprises a means for detecting a potentially unauthorized removal of the asset.

21) The integrated system of claim 18, wherein the system further comprises at least one global positioning satellite from which position information transmissions can be received by a component of the NSBD.

22) The integrated system of claim 18, wherein the NSBD is in close proximity to the asset in a manner selected from the group consisting of: as an item within but not affixed to the asset; affixed to the inside of the asset; affixed to the outside of the asset; as an integral component of the asset; affixed to a dolly for moving the asset, and as an integral component of a dolly for moving the asset.

23) The integrated system of claim 18 wherein when the ability to transmit information from the NSBD is on, the transmission may be periodic and or generated in response to a transmission from the central server or a client.

24) The integrated system of claim 18 wherein the NSBD further comprises a means for calculating at least one of the location and motion of the asset as a function of supplemental data received from a cellular telephone, assisted GPS, and or an inertial navigational system.
